(19) United States
(12) Patent Application Publication
(10) Pub. No.: US 2013/0151005 A1
(43) Pub. Date: Jun. 13, 2013

(54) PILL DISPENSING APPARATUS

(71) Applicants: William Olin Gerold, Bridgman, MI (US); William Jason Gerold, Bridgman, MI (US)

(72) Inventors: William Olin Gerold, Bridgman, MI (US); William Jason Gerold, Bridgman, MI (US)

(21) Appl. No.: 13/712,388

(22) Filed: Dec. 12, 2012

Related U.S. Application Data
(60) Provisional application No. 61/569,840, filed on Dec. 13, 2011.

(51) Int. Cl. G06F 19/00

(52) U.S. Cl. CPC G06F 19/3462
USPC 700/235

(57) ABSTRACT

Automated pill dispensing apparatus for filing prescriptions in a retail pharmacy. The pill dispensing apparatus can automatically dispense pill form medicines from dispenser units into vials to fill customer prescription orders and place the filled vials in a smart tote assigned to that customer order. The smart totes can include a display listing the automatically filled and manually prescriptions required to complete the customer order assigned to that smart tote. A plurality of smart totes can be positioned on a conveyor arranged to transport the smart totes to one side of the pill dispensing apparatus and a return conveyor. The pill dispensing apparatus can include a controller, a plurality of storage locations for dispenser units, one or more vial feed modules, one or more labeler modules, a vial transport module and an order database.

### BACKGROUND OF THE INVENTION

### Field of the Invention

The present invention relates to an automated pill-dispensing apparatus, and more particularly relates to a modular compact pill-dispensing apparatus for automated dispensing of pills in retail pharmacy environments.

There is a need to optimize use of pharmacist time, since the time of a pharmacist is expensive. In particular, there is a need to let a pharmacist use his/her expertise without burdening him/her with mundane work such as counting pills and placing them in bottles. Further, it is desirable to reduce the amount of time a pharmacist spends walking around the pharmacy area, not only to reduce wasted time but also to reduce fatigue of the pharmacist as the day progresses.

There is further a need to optimize the density of storage of pills. In many pharmacies, pills are stored in every nook and cranny possible. Also, the logistics of stored pills relative to the customers and to the pharmacist should preferably be improved. As part of the logistics, it is important to keep in mind the security of pills, the cleanliness, and the ability to keep the areas clean, especially in the retail environment where cleanliness can be a problem.

Another concern is equipment. Any automated equipment must be compact, flexible, and adjustable for optimally handling different types of pills. However, standardized components should preferably be used, including components that are easily serviceable by exchanging modules in minutes, reliable, robust, durable, low maintenance, simple to operate, low-cost, and that require a relatively lower capital investment. Further, any programmed features must be configured to optimize quality control and efficiency and control of the operation.

There is a need to increase the accuracy and reduce the errors in filling prescriptions. As part of this, there is a need to improve pill handling and accuracy of pills counts. These are difficult problems, because of the difference in sizes and shapes of pills make pill handling difficult. At the same time, different sizes and shapes of pills are required so that a pharmacist (and patient) can recognize wrong pills. Further, pill handling must deal with quality control issues, including the fact that pill counting is a relatively mundane and boring task.

There is a need to provide adjustability and reliability in pill handling equipment. There is a need to be able to adjust for different pills on site without requiring customized specially-ordered equipment or part. There is a need to reliably and accurately drop pills into vials, while still providing the flexibility that will allow pharmacists to still provide the human control required for dispensing medicines critical to the health of patients.

There is a need to increase storage capacity of the dispensers to reduce the time required to replenish inventory.

Another need is the ability to quickly, without tying up the system, return previously filled orders that were not picked up back into the dispenser and to automatically adjust the inventory.

In a retail pharmacy the filling of prescription is a very labor intensive process making it prone to errors, with some of those errors being fatal for hundreds or even thousands every year. Automation to date has concentrated mostly on; saving labor by automating redundant tasks, reducing counting errors, and adding verification on the drugs that are automatically filled. Some have provided separate software packages to better manage the workflow, but it still leaves it to the user to manually follow through and “sort it out”.

Another issue is security. Any automated equipment should provide good security and resistance to theft and tampering. As part of this software and programming, it is desirable to provide a refill procedure that not only controls refilling and prevents errors in filling storage units with wrong pills, but also that keeps track of pill counts.

A major issue with current technologies available is with location of the system, floor space in a retail pharmacy is at a premium and the systems currently in use require removing shelves from the pharmacy. The other issue with this is the manual transfer of the automated prescription to the workflow counter. The intent with the new method described within is to place the automation directly in the workflow, eliminate the manual transfer of automatically filled prescriptions, and provide interactive feedback on the status of the orders being processed.

Accordingly, an automated apparatus is desired that provides the advantages noted above and that solves the disadvantages.

### SUMMARY OF THE INVENTION

According to one embodiment of the present invention, a pill dispensing apparatus for filing one or more prescriptions for a customer order can have a plurality of storage locations for pill form medicines, a controller and a conveyor extending substantially across the pill dispensing apparatus between one side and the other. A plurality of smart totes can be carried on the conveyor for movement across the pill dispensing apparatus toward the second side. The smart totes can be arranged for accumulating prescriptions for a customer's order and can include a vial storage area arranged to receive vials of automatically filled prescriptions for a customer's order and a storage area for manually filled prescriptions. The smart totes can have a circuit board and microprocessor arranged to provide an interface connection to controller and a tote display connected to the circuit board and arranged for displaying the prescriptions for the customer's order assigned to the smart tote by the controller. A communication link can operatively connect the interface of respective smart totes with the controller. A plurality of dispensing units can be respectively positioned in the plurality of storage locations, each arranged to hold and dispense a pill form medicine to fill a prescription. The pill dispensing apparatus can include at least one vial feed module operatively connected to the controller and arranged to store empty vials and sequentially feed empty vials to at least one labeler module operatively connected to the controller and arranged to receive vials from the at least one vial feed module. The at least one labeler module can, under control of the controller, print and apply a label for one of the prescriptions for a customer's order to a vial. A vial transport module can be operatively connected to the controller and movably mounted to the pill dispensing apparatus to transport a labeled vial from the one of the at least one labeler modules to a location for automatically filling the vial for one of the prescriptions from a dispensing unit containing the pill form medicine corresponding to the label, and transport the vial containing the one of the prescriptions to the vial storage area on the smart tote assigned to the customer's order.

### BRIEF DESCRIPTION OF THE DRAWINGS

FIG. 1 is a view of a pill dispensing apparatus according to the invention positioned in a retail pharmacy environment.

FIG. 2 is a perspective view of the pill dispensing apparatus illustrated in FIG. 1

FIG. 3 is a partially exploded perspective view of the pill dispensing apparatus illustrated in FIG. 2.

FIG. 4 is a partial rear perspective view of the pill dispensing apparatus illustrated in FIG. 2.

FIG. 4A is an expanded view of a portion of FIG. 4 illustrating the feed head.

FIG. 5 is a perspective view of a dispensing unit that can be used in the pill dispensing apparatus.

FIG. 5A is a partially exploded perspective view of the dispensing unit in FIG. 5 illustrating a desiccant drawer and funnel drawer.

FIG. 6 is a perspective view of the dispensing unit illustrated in FIG. 5 with the container partially broken away to illustrate elements of the dispensing unit.

FIG. 6A is a partial perspective view of the opposite end of the dispensing unit illustrated in FIG. 5 partially broken away to illustrate the circuit board housing and latch and roller drive train.

FIG. 7 is a partial perspective view of a vial transport module with portions cut away to show feed head elements that can be used with the invention.

FIG. 7A is a partial exploded view of a feed head and scale that can be used with the invention.

FIG. 8 is partial perspective view of a gripping device that can be used with the invention.

FIG. 9A is a partial rear perspective view of the vial transport module illustrating the feed head module rotatable arm of FIG. 6 in a “side” position.

FIG. 9B is a partial rear perspective view of the vial transport module illustrating the feed head module rotatable arm of FIG. 6 in a “down” position.

FIG. 9C is a partial rear perspective view of the vial transport module illustrating the feed head module rotatable arm of FIG. 6 in an “up” position and the scale and scale carrier positioned at the bottom of the retriever frame to illustrate components of the scale carrier.

FIG. 10 is a partial sectional view of a dispensing unit illustrating the feed head module positioned at a dispensing unit during a dispensing operation.

FIG. 10A is an enlarged partial perspective view illustrating the feed head module engaging a dispensing unit.

FIG. 11 is a partial sectional view illustrating the feed head module positioned at a dispensing unit at the end of a dispensing operation.

FIG. 11A is a partial view illustrating the feed head module of FIG. 11 with the dispensing unit removed.

FIG. 12a is a partial perspective view illustrating an uprighter module that can be used with the pill dispensing apparatus according to the invention.

FIG. 12b is a partial perspective view illustrating an alternate uprighter module that can be used with the pill dispensing apparatus according to the invention.

FIG. 13 is a partially cut away perspective view with a portion of a vial removed of a labeler module that can be used with the pill dispensing apparatus according to the invention.

FIG. 14 is a partial perspective view illustrating a vial transport module, vial feed module and a labeler module in relative position for retrieving a labeled vial from the labeler according to the invention.

FIG. 14A is a partial perspective view illustrating the vial transport module of FIG. 14.

FIG. 15 is a partial perspective view illustrating a feed head module, gripper and labeler module with the gripper engaging a vial in the labeler module.

FIG. 16 is a schematic drawing illustrating a control system for the pill dispensing apparatus according to the invention and interface with a pharmacy computer network.

FIG. 17 is a perspective view illustrating a typical servomotor or actuator that can be used with the pill dispensing apparatus according to the invention illustrating a typical mounting bracket and a typical control board.

FIG. 18 is a perspective view illustrating a lift transfer module that for the pill dispensing apparatus according to the invention.

FIG. 18A is a partial exploded perspective view of the lift transfer module illustrated in FIG. 18.

FIG. 19 is a partial perspective view illustrating a smart tote that can be used with pill dispensing apparatus according to the invention.

FIG. 19A is a partial section side view of the smart tote illustrated in FIG. 19 illustrating components of the smart tote.

FIG. 19B is a partial section side view of the smart tote illustrated in FIG. 19 illustrating components of the smart tote.

FIG. 19C is an enlarged partial section view illustrating a portion of a conveyor lock for the smart tote of FIG. 19

FIG. 19D is a perspective view illustrating a cam for the conveyor lock illustrated in FIG. 19C.

### DETAILED DESCRIPTION OF THE INVENTION

Space is expensive in retail environments, such as in retail chain stores and local retail drug stores. Typically, pills are stored in bulk in a location well behind a countertop, where the pills are safe from theft, and where there is sufficient room to store the pills in head-high dense-storage cabinets. However, this requires space in the pharmacy area, and further this requires that the pharmacist walk back and forth between customer/patients and the storage cabinets.

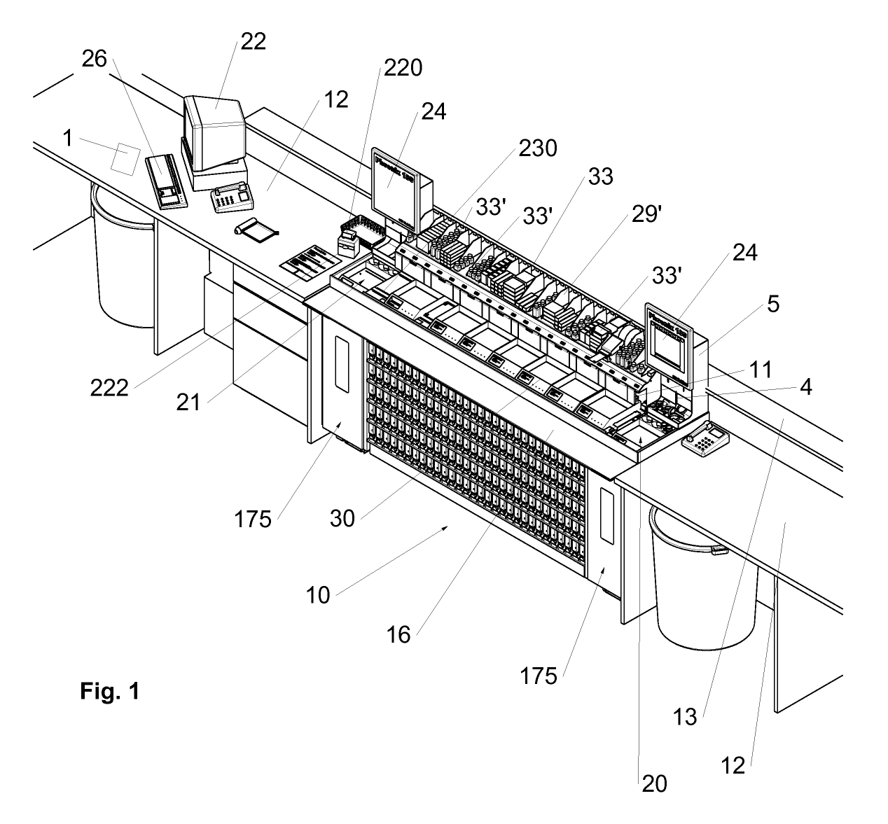

Referring to FIGS. 1-3, a pill dispensing apparatus 10 according to the invention can be positioned in a workflow area of a retail pharmacy adjacent a counter 12. The pill dispensing apparatus 10 can fill prescription orders 1 automatically into vials 11 and load vials 11 into a smart tote 30 that can accumulate prescriptions required to fill a customer's order 2. The pill dispensing apparatus 10 can automatically advance smart totes 30 on a conveyor 230 that can be built into the top surface of the pill dispensing apparatus 10. Smart totes 30 can provide active feedback to the pharmacist of what is missing to complete a customer order. Pill dispensing apparatus 10 can provide tremendous improvements in reduced space requirements, increased security, and pill storage density, reduced wear on the pharmacist, and improved efficiency and accuracy and timeliness of the operation of filling prescriptions.

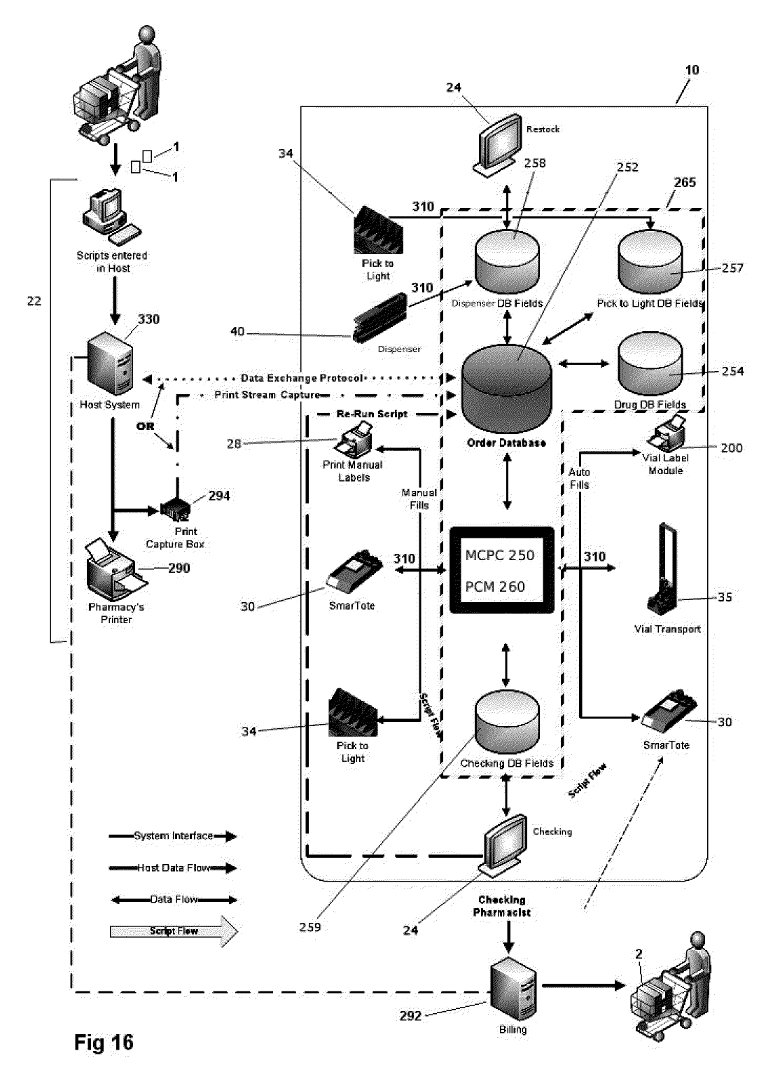

As shown in FIGS. 1 to 3 automatic pill dispensing apparatus 10 can be located adjacent a countertop 12 in a retail pharmacy in a position allowing a pharmacist to serve a customer and simultaneously fill prescriptions while standing at the counter 12. A pharmacy computer 22 that can have a keyboard 26 can be positioned on countertop 12. Pharmacy computer 22 can be used to enter prescription orders 1 into pill dispensing apparatus 10 via data exchange protocol or print stream capture to the machine control personal computer (sometimes referred to as “MCPC”) 250 that can be part of pill dispensing apparatus controller 265 (described below) as desired by the pharmacy. Pharmacy computer 22 can be connected to a pharmacy printer 290 (see FIG. 16), and can be connected to a pharmacy billing system 292, in a pharmacy computer network again as desired by the pharmacy. The pharmacy computer 22 can be connected to the internet so that the pharmacy can receive prescription orders 1 for customers electronically to be fed into pill dispensing apparatus 10. The pharmacy computer 22 and pharmacy network may sometimes be collectively referred to as the host system 330. To provide privacy security for customer's information sensitive customer information can be maintained on the pharmacy host system 330. Order information for respective customer orders can be transmitted to the pill dispensing apparatus 10 to fill customer's prescription orders as will be described below without communicating sensitive customer information.

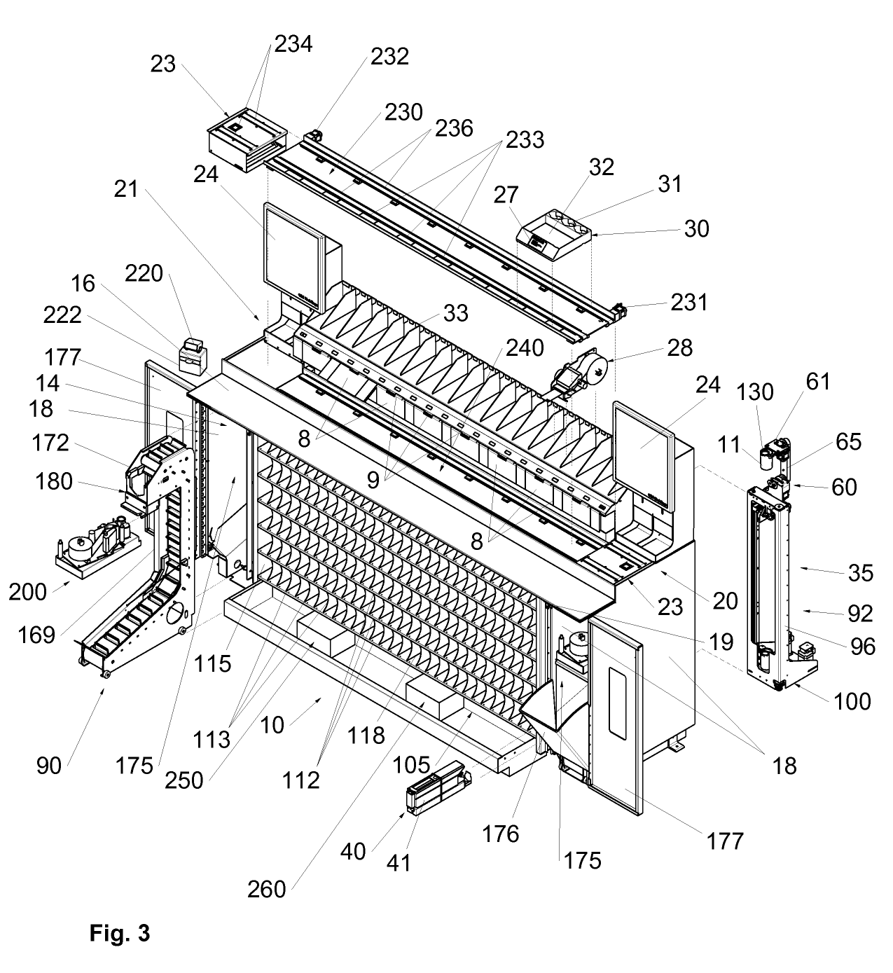

The pill dispensing apparatus 10 can include an array of dispensing units 40 for storing medicine in the form of pills, tablets, capsules (hereafter collectively called “pills” in this application) in bulk. An array of dispensing units 40 can be carried on a matrix frame 105, and a vial transport module 35 can be positioned behind the matrix frame 105 carrying dispensing units 40 for locating a feed head module 60 that can be carried by the vial transport module 35 to behind selected ones of the dispensing units 40 for dispensing pills from a dispensing unit 40 into a vial 11. As will be described in more detail below, and as illustrated in FIGS. 3, 5, 5A, 6 and 6A, dispensing units 40 can include a generally rectangular container 41, rollers 52 and 53 positioned in the bottom of container 41, and a pill gate 54 that can be positioned in container 41, adjacent an outlet 38 for movement toward and away from rollers 52 and 53. Dispensing unit 40 can include a driver 55 to rotate rollers 52 and 53, a funnel drawer 56 for directing pills, not shown, passing under pill gate 54 when rollers 52 and 53 are operated into a vial 11 below funnel drawer 56 as described in more detail below. A tab 57 can pivot pill gate 54 on a pivot 58 to lift pill gate 54 relative to rollers 52 and 53 allowing pills to pass under pill gate 54 through outlet 38 into funnel drawer 56 to drop into a vial 11. Pills passing under pill gate 54 through outlet 38 and funnel drawer 56 can drop into a vial 11 that can be carried by feed head module 60 and positioned under funnel drawer 56. Container 41 can also have a desiccant drawer 340 that can be slidably mounted below top wall 46. Desiccant drawer 340 can include a front wall 341, side walls 342, rear wall 343 and perforate bottom wall 344 that can include openings 347 to allow desiccant material, not shown, contained in desiccant drawer 340 to absorb moisture from pill chamber 50 to help keep pills stored in pill chamber 50 dry and to prevent pills from sticking to one another. Desiccant drawer 340 can include tabs 345 on the top edge of side walls 342 that can slidably mount desiccant drawer in slots 346 that can be located adjacent the bottom surface of top wall 46. Desiccant drawer 340 can be opened as desired by the pharmacist to replace desiccant material as needed.

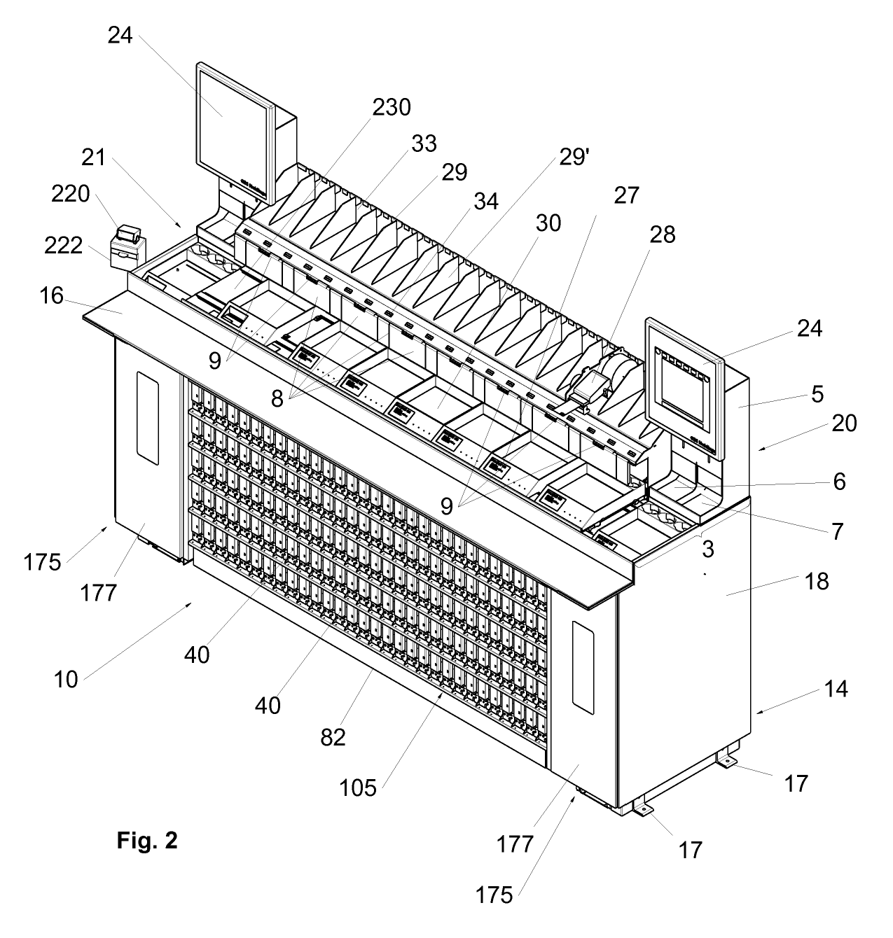

Referring to FIGS. 2 and 3, a prescription checking station 20 can be provided that can include a touch screen computer 24 for viewing patient prescription information, and a manual printer 28 for printing labels for manually filed prescriptions. Touch screen computer 24 can be tablet computer or can be a monitor connected to well known processor or CPU, not shown. Touch screen computer 24 can be mounted on a lid storage hopper 5 that can have two compartments arranged to gravity feed lids to outlets 6 and 7 for vial lids 4. Lid storage hopper 5 can hold a quantity of vial lids 4 (see FIGS. 1 and 2) for convenient access when a pharmacist has completed checking a vial 11 at a checking station 20. Touch screen computer 24 can be connected to controller 265 to display information about a customer's prescriptions in a smart tote 30 positioned at checking station 20. While checking station 20 is shown at the right end of pill dispensing apparatus 10 in FIGS. 1-3 with a restocking station 21 shown on the left end of pill dispensing apparatus 10, the checking station 20 and restocking station 21 could be reversed if desired by a pharmacy.

Referring to FIG. 16, MCPC 250 can operate a master control program for the pill dispensing apparatus 10 and can communicate with the operating elements of the pill dispensing apparatus 10 via a LAN router and power communications module (sometimes referred to a “PCM”) 260 that can be an interface board providing power and communications to control boards used in the pill dispensing apparatus 10 as will be described in more detail below. MCPC 250, a LAN router, if used and PCM 260 together with a dispensing database 258, order database 252, pick to light database 257, drug database 254 and checking database 259 (see FIG. 16) will sometimes be collectively referred to as controller 265. MCPC 250, a LAN router and PCM 260 can be a combined module or can be independent operating modules as desired. While MCPC 250 is illustrated as a single personal computer (PC) those skilled in the art will understand that multiple PCs can be used instead of a single PC so that one PC can be arranged to control machine elements and one or more other PCs can be arranged to operate one or more of the databases identified above. The components of controller 265 can be positioned in a drawer 82 that can be positioned at the bottom of matrix frame 105 although those skilled in the art will understand the controller 265 and/or some of the components of controller 265 can be located at other locations as desired. PCM 260 can be operably connected to the operating elements of pill dispensing apparatus 10 for operating the pill dispensing apparatus 10 as will be described in detail below.

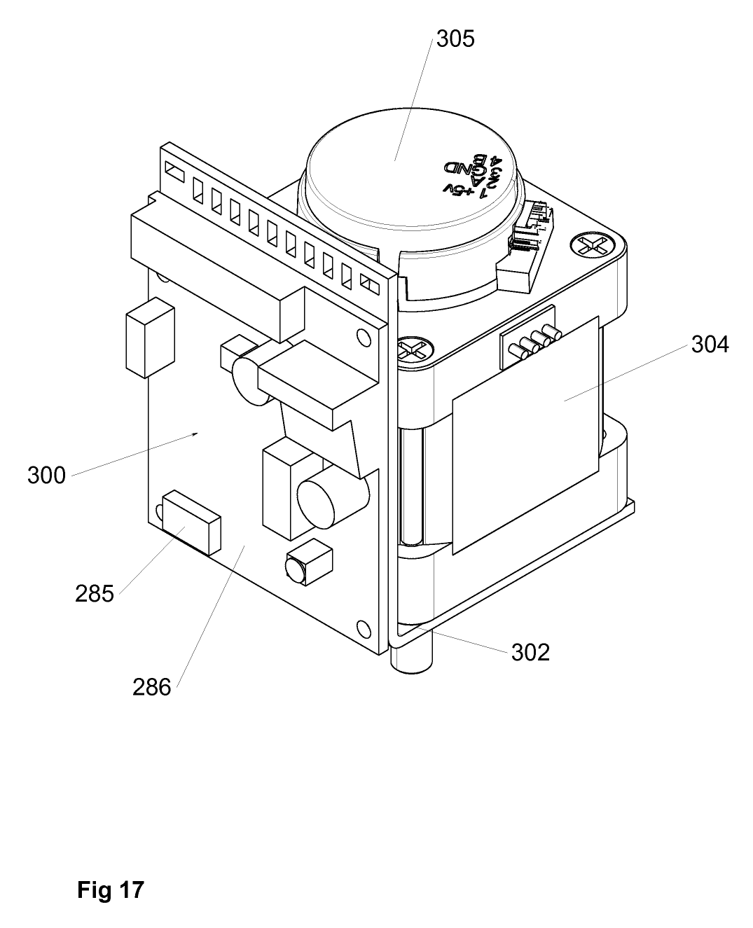

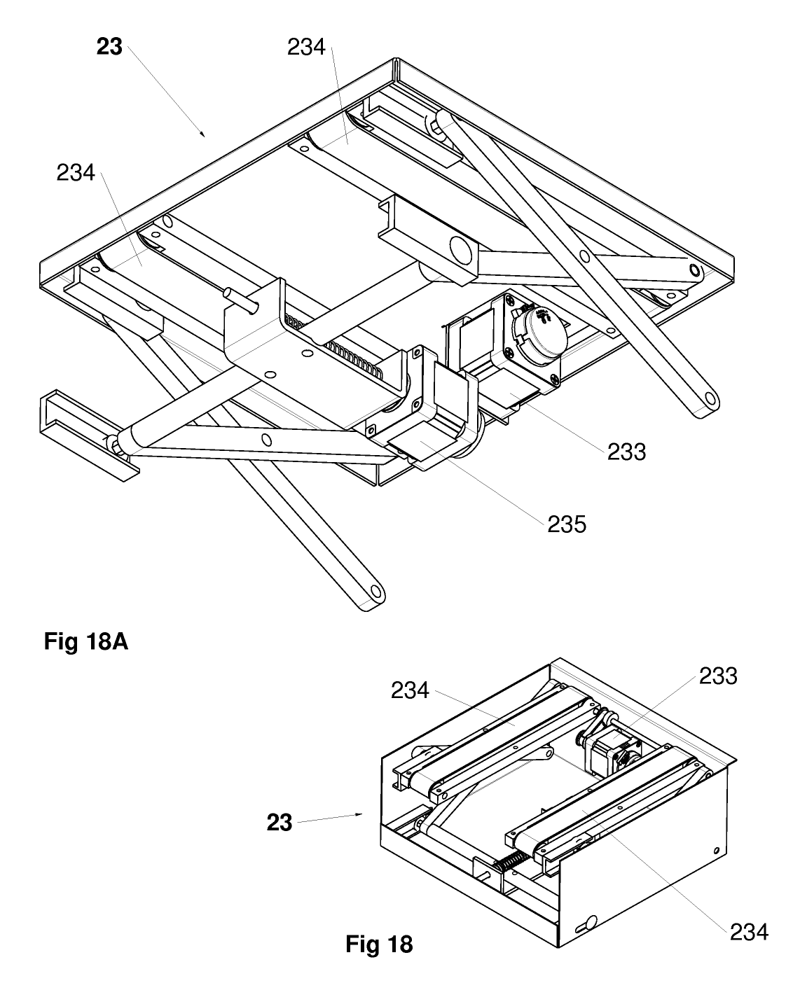

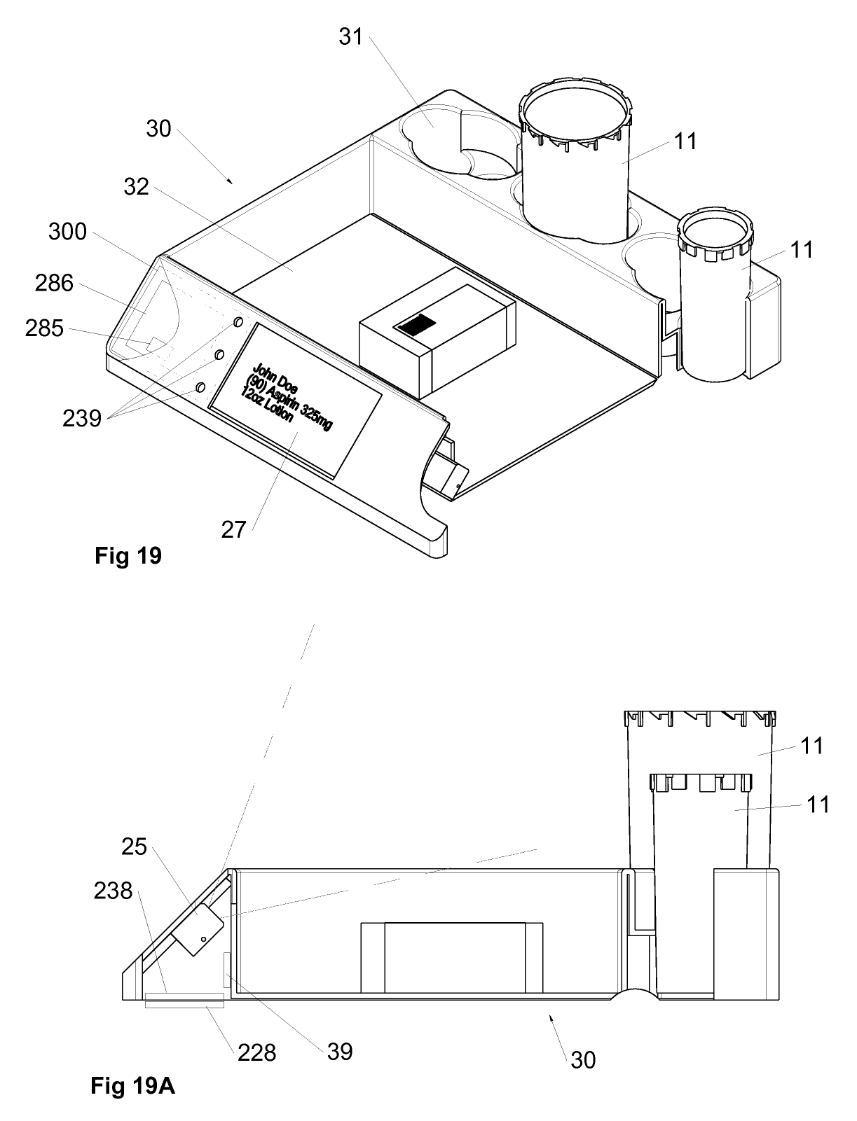

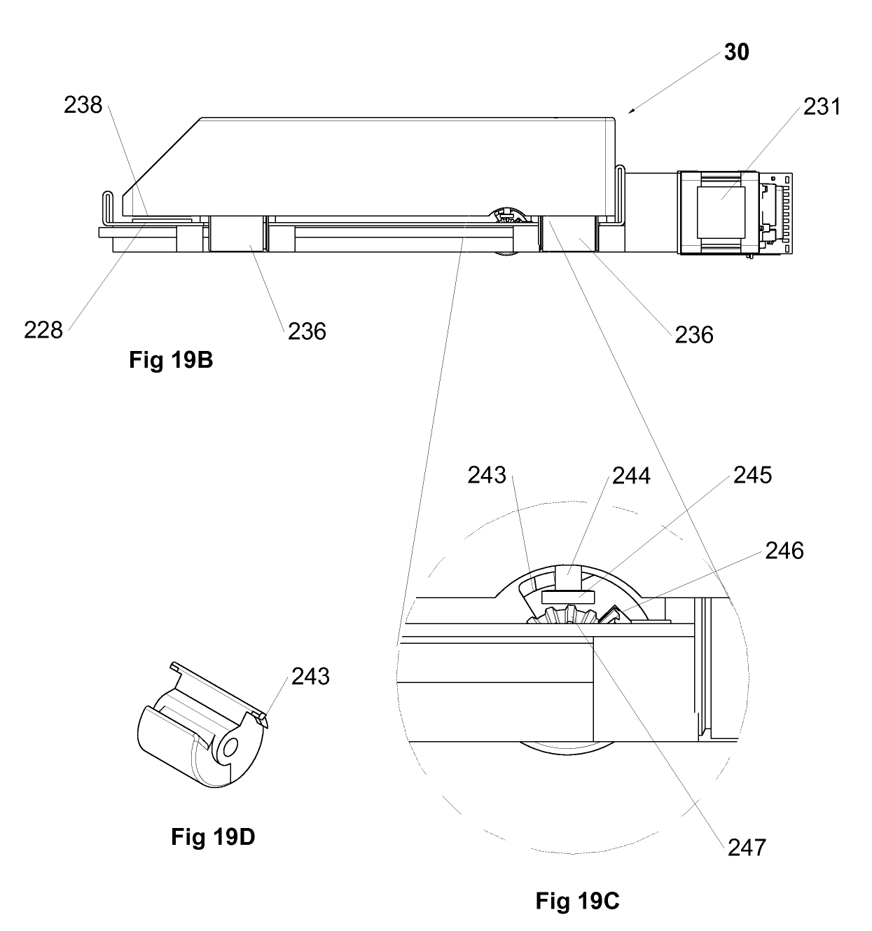

The structure for a pill dispensing apparatus 10 can include two housings 14 that can be generally U-shaped having side walls 18, a rear wall, not shown, a bottom wall 15 and a partial top wall, not shown, that can support lid storage hopper 5 and touch screen computer 24 for a checking station 20 or restocking station 21. A housing 14 can be provided for each of the right and left end of pill dispensing apparatus 10 and can be mirror image structures if desired. A work surface 16 can be positioned across housings 14 to form part of the top surface of pill dispensing apparatus 10 at elbow height so that the work surface 16 is positioned for use by a standing pharmacist handling customer orders on the work surface 16. Those skilled in the art will understand that the work surface 16 can be positioned at a vertical height to correspond to the physical requirements of a particular retail pharmacy environment. The “pharmacist side” of the counter 12 can be open to accommodate a pill dispensing apparatus 10. A front shelf 13 can be provided on counter 12, if desired, to hold papers and items on counter 12 and can extend across the space occupied by pill dispensing apparatus 10 as illustrated in FIG. 1. A frame, not visible, for supporting conveyer 230 and return conveyor 240 can also be connected to housings 14 to form part of the top surface 3 of pill dispensing apparatus 10. Conveyor 230 and return conveyor 240 can have a plurality of charging pads 228 for charging rechargeable batteries 39 powering the smart totes 30 as will be described in greater detail below. There can be a plurality of gates 8 pivotally mounted above conveyor 230 that can be hinged under storage rack 30 as described in more detail below. Gates 8 can be arranged to preclude access to vial storage receptacles 31 when smart totes 30 are positioned on conveyor 230. Further gates 8 can pivot outwardly to allow a smart tote 30 to be removed from conveyor by the operator(s) when not locked, again as described below. Conveyor 230 and return conveyor 240 can be identical and interchangeable conveyors. Conveyor 230 and return conveyor 240 can have a conveyor drive motor 232 and a conveyor lock motor 231 described in more detail below (see FIG. 3) that can each include a control board 300 including a circuit board 286 and a microprocessor 285, not visible, that can be generally similar to the typical control board 300 illustrated in FIG. 17. Conveyor 230 and return conveyor 240 can each have two conveyor drive belts 236 driven by conveyor drive belt motor 232 (see FIGS. 3 and 19B), although those skilled in the art will understand the conveyor 230 and return conveyor 240 can have a single conveyor drive belt or more that two conveyor drive belts as desired. Conveyor lock motor 231 can drive a bevel gear 246 that can mesh with bevel gear 247 to drive locking cam shaft 242 (not visible). Locking cam shaft 242 can have a plurality of locking cams 243 that can be arranged to engage locking posts 244 that can be connected to the lower surface of respective smart totes 30 (see FIG. 19C). Locking posts 244 can have a head 245. Locking cams 243 can be arranged so that locking cams 243 can engage locking posts 244 and head 245 depending on which portion of locking cams 243 engages the smart totes 30. For example, in a first position locking cams 243 can be positioned so that none of the locking posts 244 is engaged and smart totes 30 are free to be moved or removed from conveyor 230. In a second position locking cams 243 can be arranged and positioned such that all smart totes 30 on conveyor 230 are free except of the smart tote 30 adjacent prescription checking station 20. In a third position locking cams 243 can engage the locking posts 244 for all smart totes 30 on conveyor 230 so that all smart totes 30 are stopped from movement along conveyor 230. In a fourth position locking cams 243 can engage locking posts 244 and heads 245 so that all smart totes 30 on conveyor 230 are stopped and locked in position.

Each housing 14 can include space for a vial feed module 90 and labeler module 200 and can provide storage for vials 11 as will be described below. One or more retainers 17 can be connected to housings 14 and secured to the floor to securely position the pill dispensing apparatus 10 adjacent counter 12. Those skilled in the art will understand that a variety of different retainer arrangements can be used to position the pill dispensing apparatus 10 under a counter or other retail work surface where customers can pickup their prescription order(s) 1. Further, those skilled in the art will understand that the pill dispensing apparatus 10 can be used in locations other than directly in a pharmacy workflow area.

Pill dispensing apparatus 10 can be highly modular, and can take advantage of off-the-shelf components that can be purchased and used in pill dispensing apparatus 10 by attaching such components to housings 14. Accordingly, many different options can be added or deleted based on a pharmacist's or storeowner's preference, or based on customer preferences. For example, the touch screen computers 24 and the conveyor 230 and return conveyor 240 can be purchased from suppliers as desired.

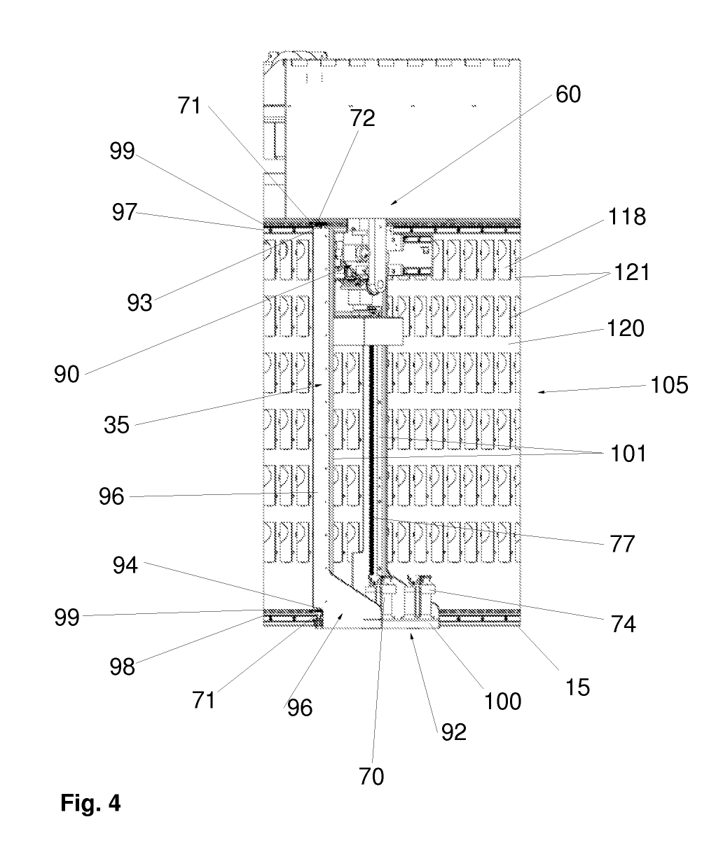

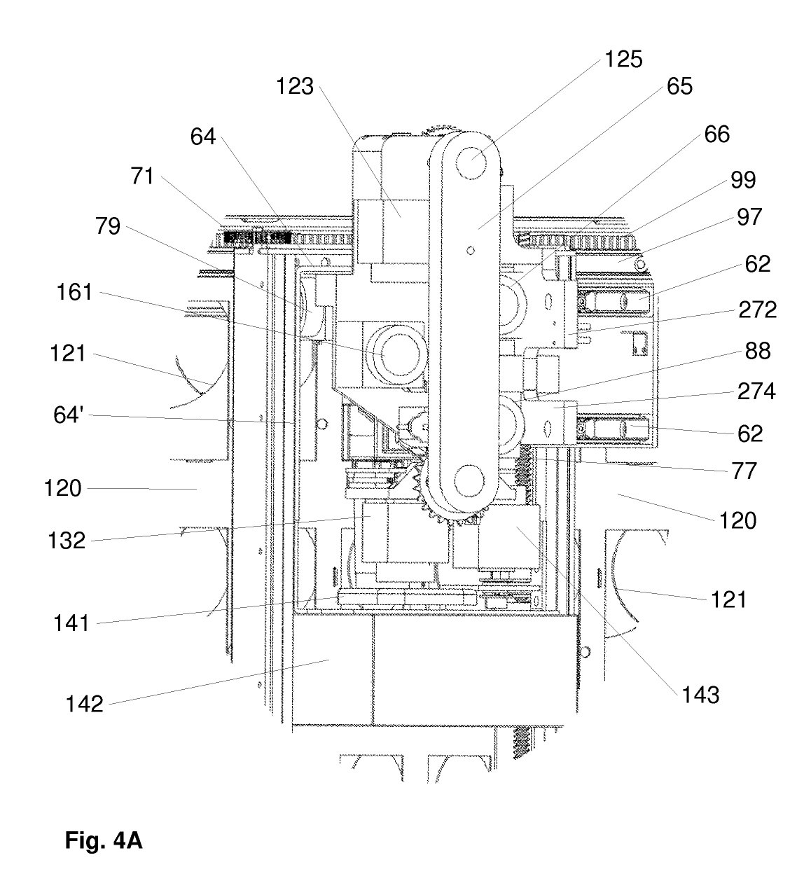

Referring to FIGS. 2, 3 and 4, matrix frame 105 can include a pair of vertical panels 115 that can be connected together at the top and bottom, not shown, of vertical panels 115. A series of shelf panels 112 and vertical dividers 113 can be arranged to form a matrix of storage locations 118 between vertical panels 115 and the top and bottom walls, not shown, to support dispensing units 40 on the pill dispensing apparatus 10 in the storage locations 118. A face plate 120 can be provided on the rear side of matrix frame 105 (see FIG. 4) that can prevent dispensing units 40 from sliding through the storage locations 118 and can include a plurality of openings 121 each corresponding to a storage location 118 for feed head module 60 access to the dispensing units 40 positioned in the respective storage locations 118. Matrix frame 105 can be pivotally connected to pill dispensing apparatus 10 by hinging a front edge of matrix frame 105 to a housing side wall 18 such as at hinge point 19 that can extend vertically along housing side wall 18 and vertical panel 115 (see FIG. 3). Pivotally mounting matrix frame 105 to pill dispensing apparatus 10 can allow access to vial transport module 35 and feed head module 60 without moving the entire pill dispensing 10. Low weight can be important in order to facilitate moving the pill dispensing apparatus 10 to a retail location and for moving the matrix frame 105 for access to the rear of the pill dispensing apparatus 10 for service or modification. Matrix frame members can be made of formed thin gage stainless steel or similar lightweight construction and can be supported in pill dispensing apparatus 10 on wheels, not visible, to facilitate pivoting matrix frame 105 outwardly to access the vial transport module 35 and feed head module 60. The size of matrix frame 105 can also affect the frame requirements.

The shelf panels 112 can be supported at each end by the vertical panels 115 and at regular intervals in-between by vertical dividers 113. Shelf panels 112 can rest on slots in the vertical dividers 113. The intersecting shelf panels 112 and vertical dividers can define an array of storage locations 118 shaped to receive the dispensing units 40. Preferably, the shelf panels 112 and vertical dividers 113 can be relatively thin to take up a minimum of space. The embodiment illustrated in FIGS. 2-4 matrix frame 105 includes an array of storage locations 118 that is six rows high and thirty columns wide. This embodiment provides one hundred eighty storage locations 118 for dispensing units 40. Nonetheless, it will be understood by a person skilled in the art that the number of rows and columns can be increased or decreased to meet specific pill dispensing apparatus application requirements. In addition, those skilled in the art will understand that the matrix array of storage locations 118 can be formed in other ways as desired.

A dispensing unit database 258 of the location of dispensing units 40 and their respective storage locations 118 can be maintained as a part of controller 265. Controller 265 can operate pill dispensing apparatus 10, monitor, sequence and operate the vial transport module 35 and vial feed module 90 so that pills from different dispensing units 40 can be selected and filled into individual vials 11 and placed in a smart tote 30, as will be described in detail below. In addition to controller 265 the pill dispensing apparatus 10 can include control boards 300 including a circuit board 286 and a microprocessor 285 embedded on the control boards 300 to control motions and communications of operating components of pill dispensing apparatus 10. Control boards 300 can include microprocessors 285 on circuit boards 286 for local control of the motor; microprocessors 285 on a circuit board 286 on dispensing units 40 to monitor the respective dispensing units 40 and for displaying via LEDs inventory status, identification of the dispensing unit and contents and any faults; microprocessors 285 on a circuit board 286 on smart totes 30 to communicate with the controller 265 and drive displays 27 on the respective smart totes 30; and checking station 20 touch screen computer 24 running graphical user interface software. FIG. 17 illustrates a typical control board 300 mounted on a mounting bracket 302 to a typical servomotor 304 that can typically include an encoder 305 to communicate servomotor shaft position to control board 300 and hence to controller 265. Control boards 300 for operating components of pill dispensing apparatus 10 can communicate with controller 265 via a communication bus 310 and power bus 312 (not shown), see FIG. 16, that can connect PCM 260 with the operating component control boards 300. Communication bus 310 can be a standard two wire communication circuit that can be part of a wiring harness for fixed elements or a ribbon cable for movable elements. Alternately electronic communication such as Zigbee, Bluetooth or WiFi communication networks can be used for communication between controller 265 and operating component control boards 300. The power link 312 can be a standard low voltage D.C. circuit such as a 34v. D.C. circuit. Portions of the power bus 312 can be lower voltage such as connections to dispensing units 40 that can desirably operated at lower voltage, such as 5 v. D.C., due to lack of movable elements to be driven by the power link 312 to dispensing units 40.

As noted above and as illustrated in FIGS. 3, 4, 4A, 9A, 9B and 9C vial transport module 35 can be positioned adjacent the rear of matrix frame 105, and can be operated to retrieve a vial 11 from a labeler module 200 after a label 206 for a prescription order 1 has been applied to the vial 11, position the vial 11 for receiving pills from the dispensing unit 40 in a storage location 118 corresponding to the prescription on the vial 11, and then place filled the filled vial 11 in a smart tote 30 on conveyor 230 as will be described in detail below. Referring to FIGS. 3, 4 and 4A, vial transport module 35 can include an x-y-z retriever 92. Those skilled in the art will recognize that x-y-z retrievers are available commercially, and that different x-y-z retrievers can be used successfully in pill dispensing apparatus 10. For example an x-y-z retriever produced by Animatics Company can be used. Vial transport module 35 can include a high-rise beam-type retriever frame 96 that can include a top slider 93, not visible, and a bottom slider 94, not visible, for horizontal movement in an “x” direction along a top rail 97 and a bottom rail 98 that can be connected to at opposite ends to housings 14. A reversible x-direction servomotor or actuator 70 can be mounted to a bottom plate 100 connected to retriever frame 96. X-direction servomotor 70 can include a control board 300 including a microprocessor 285 that can be carried on a circuit board 286, not visible, that can be generally similar to the typical control board 300 illustrated in FIG. 17. The x-direction servomotor 70 can be a reversible DC motor or reversible stepper motor or the like. Top rail 97 and bottom rail 98 can each include an x-direction rack 99. The x-y-z retriever 92 can include top and bottom x-direction drive gears 71 connected by x-direction drive shaft 72. The x-direction drive gears 71 can engage top and bottom x-direction racks 99. The x-direction racks 99 can extend along top rail 97 and bottom rail 98, and can be mounted to faceplate 120 that can retain the dispensing units 40 in storage locations 118 as described above. A drive pulley 75 can be connected to x-direction servomotor 70 and can be connected to driven pulley 76 that can be attached to x-direction driveshaft 72 by drive belt 78. When directed by controller 265, the microprocessor 285 for x-direction servomotor 70 can operate x-direction servomotor 70 to rotate x-direction drive shaft 72 causing x-direction drive gears 71 to move along x-direction racks 99 to move the x-y-z retriever 92, and accordingly the vial feed module 35, horizontally to a selected column of storage locations 118. The top and bottom x-direction racks 99 can maintain a vertical orientation of the x-y-z retriever 92.

A reversible y-direction servomotor or actuator 74 can be mounted to bottom plate 100 of retriever frame 96 and can include a drive pulley 75. Y-direction servomotor 70 can include a control board 300 including a microprocessor 285 that can be carried on a circuit board 286, not visible, that can be generally similar to the typical control board 300 illustrated in FIG. 17. A driven pulley 76 can be operably mounted to y-direction drive screw 77 that can be rotatably carried on retriever frame 96 with drive pulley 75 connected to the driven pulley 76 by a drive belt 78. Feed head module 60 can be slidably attached to retriever frame 96 for vertical movement in a direction “y” along rails 101 that can be positioned on opposite sides of retriever frame 96. When directed by controller 265 the microprocessor 285 for y-direction servomotor 74 can operate y-direction servomotor 74 to rotate drive screw 77 so that feed head module 60 can be moved vertically to a selected row of storage locations 118.

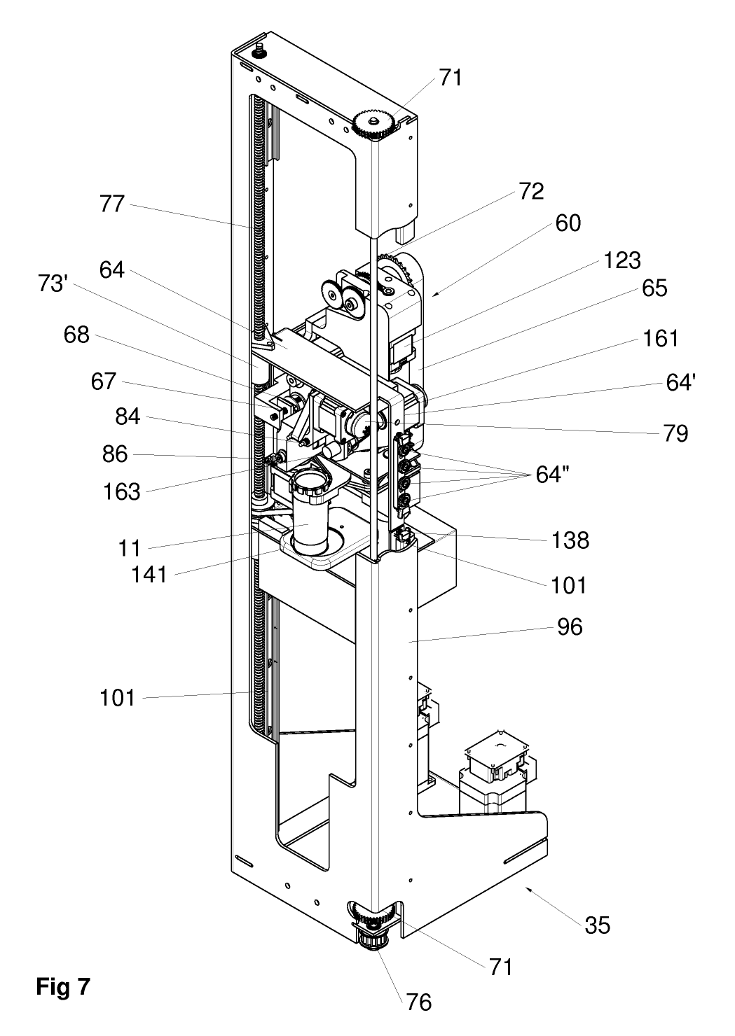

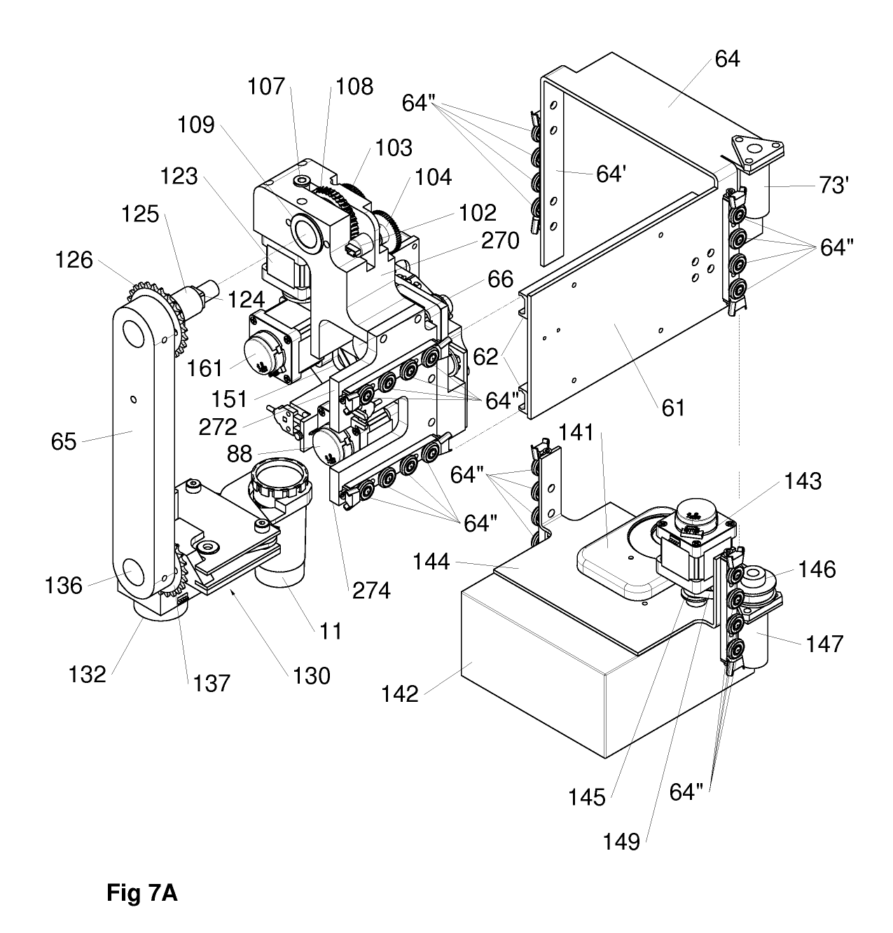

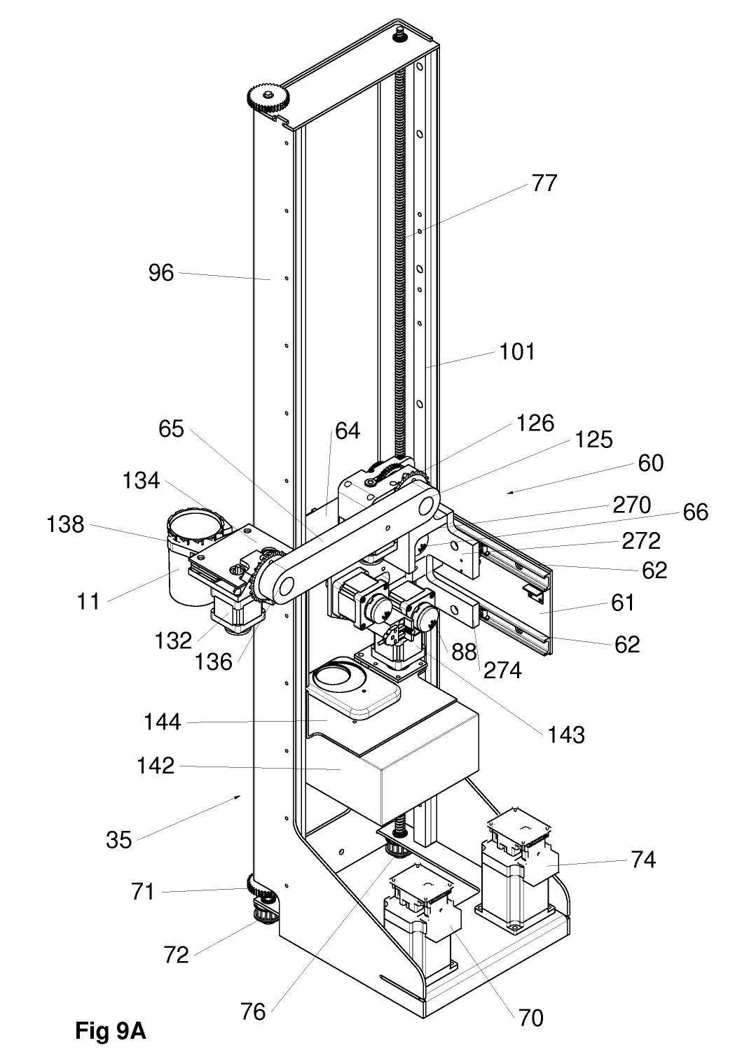

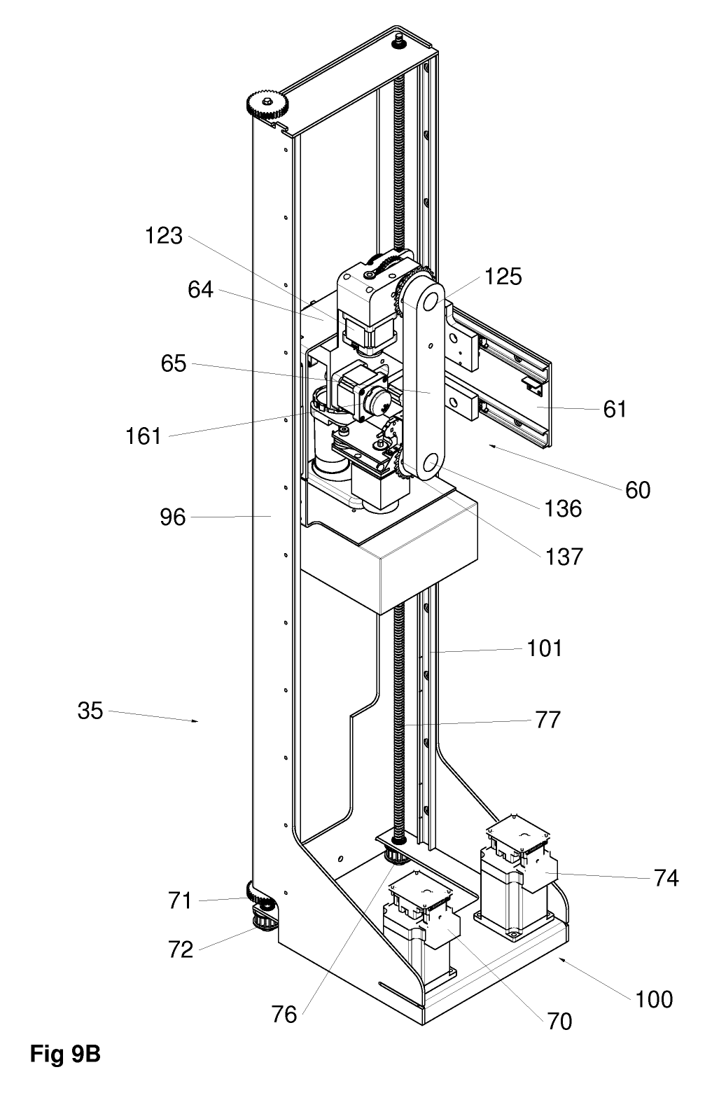

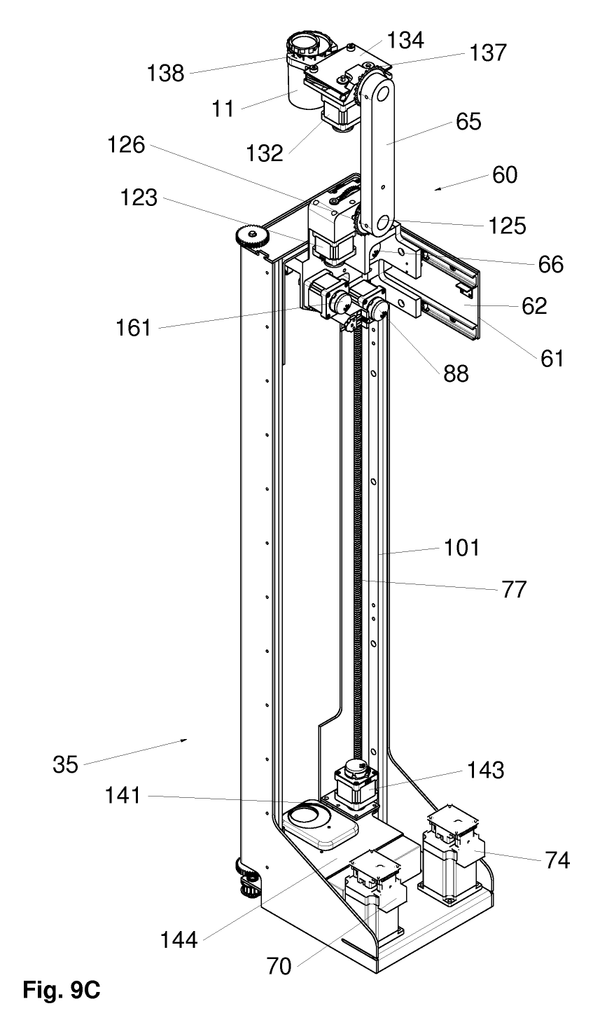

As can be seen in FIGS. 7 and 7A, feed head module 60 can be supported on a feed head support frame 64 that can include a laterally extending arm 61 on one side of feed head support frame 64 and a downwardly extending leg 64′ on the opposite side of feed head support frame 64. Laterally extending arm 61 and downwardly extending leg 64′ can each include a plurality of bearing wheels 64″ that can movably support feed head support frame 64 on y-direction rails 101. Y-direction drive nut 73, not visible, can be rotatably mounted to feed head support frame 64 by drive nut housing 73′ that can be carried on feed head support frame 64 and operably connected to y-direction drive screw 77. Thus, feed head module 60 can be vertically positioned on y-direction drive screw 77 by selectively operating y-direction servomotor 74. Feed head module 60 can include a feed head frame 270 that can have laterally extending arms 272 and 274. Laterally extending arms 272 and 274 can have a plurality of bearing wheels 64″ that can be carried on linear slides 62 mounted on laterally extending arm 61 that can slideably support feed head 60 for “z” direction (front to back) movement of feed head 60 on the retriever frame 96. A z-direction stepper-motor or actuator 66 including a z-direction motor pulley 69, not visible, can be mounted to feed head frame 270 and laterally extending section 61 can include a horizontally extending screw 67 carrying pulley/drive nut 68 that can have a drive belt, not visible, connecting the z-direction motor pulley 69 and pulley/drive nut 68. Screw 67 can have an anti-rotation mounting so that screw 67 will not rotate as pulley/drive nut 68 is rotated by z-direction motor 66. Pulley/drive nut 68 can be captured by feed head frame 270 so that, upon rotation of pulley/drive nut 68, feed head frame 270 can be moved horizontally in the z-direction along screw 67 to position feed head 60, and gripper 130 that can be carried by feed head 60 in the z-direction. Z-direction servomotor 70 can include a control board 300 including a microprocessor 285 that can be carried on a circuit board 286, not visible, that can be similar to the typical control board 300 illustrated in FIG. 17. Rotatable arm 65 can be mounted for rotation about a horizontal axis drive shaft 125 on feed head module 60. Thus, z-direction stepper motor 66 under control of controller 265 and the microprocessor 285 for z-direction servomotor 66 can operate to move feed head module 60 forwardly in the z-direction (horizontally) to position feed head module 60 in position adjacent a dispensing unit 40 for filling a vial 11; to a position feed head module 60 adjacent labeler module 200 for picking up a labeled vial 11; or to position for depositing a filled vial 11 in a smart tote 30 on conveyor 230, or rearwardly to allow rotatable arm 65 to move between the horizontal left or right and vertical up or down positions (see FIGS. 9A, 9B and 9C) without interfering with vial transport module 35 or other parts of pill dispensing apparatus 10 (sometimes referred to a “safe to rotate” position“). Rotatable arm 65 can be rotated by rotatable arm drive shaft 125 by rotatable arm drive motor 123. Rotatable arm drive motor 123 can include a control board 300 including a microprocessor 285 that can be carried on a circuit board 286, not visible, that can be similar to the typical control board 300 illustrated in FIG. 17. Further, rotatable arm motor 123 can drive a worm 107 (partially visible) that can drive a worm gear 108 that can drive a coupling 109 (partially visible) that can engage shaft drive surface 124 that, for example, can be a squared portion of rotatable arm drive shaft 123. Gripper drive sprocket 126 can be connected to rotatable arm drive shaft 125 to rotate with rotatable arm drive shaft 125. Thus, rotatable arm drive motor 123 can rotate rotatable arm 65 under control of control board 300 for the rotatable arm drive motor 123 as directed by controller 265. Rotatable arm drive motor 123 can be provided with an absolute encoder 102 in order to determine the position of rotatable arm 65 whenever pill dispensing apparatus 10 is activated and/or operating. Rotatable arm drive motor 123 can also drive an absolute encoder drive gear 103 win connection with worm gear 108. Absolute encoder drive gear 103 can drive absolute encoder driven gear 104 to operate absolute encoder 102. Absolute encoder 102 can be connected to controller 265 via the control board 300 for rotatable arm drive motor 123.

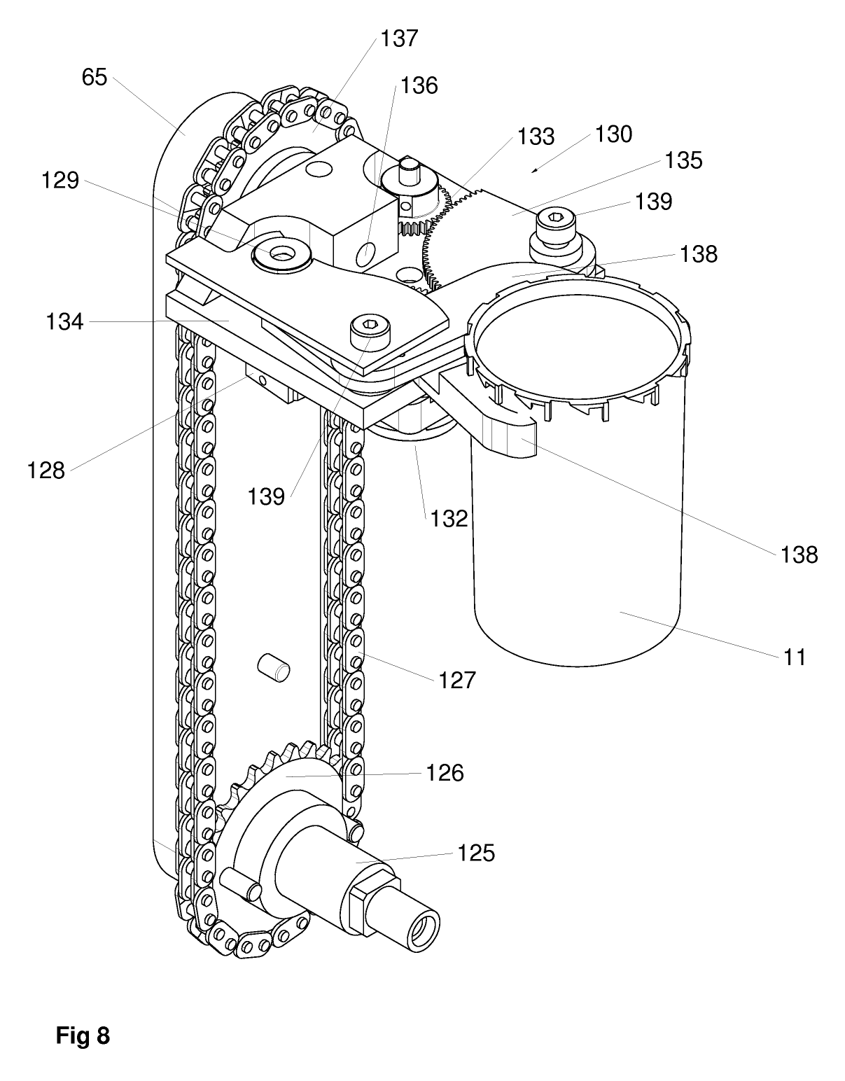

As can be seen in FIG. 8 a gripper drive stepper motor or actuator 132 can be mounted to a gripper body 134 rotatably carried on rotatable arm 65. Gripper drive motor 132 can include a control board 300 including a microprocessor 285 that can be carried on a circuit board 286, not visible, that can be similar to the typical control board 300 illustrated in FIG. 17. Gripper body 134 can include a gripper drive gear 133. The gripper drive gear 133 can drive one of a set of gripper gears 135 that can be connected to gripper fingers 138. Gripper fingers 138 can be pivotally attached to the gripper body 134 for horizontal movement around a pivot 139 for each of the gripper fingers 138. Pivot 139 can be positioned such that the arc swung by the gripper fingers 138 can maintain the front edge of different sized vials 11 roughly in the same position. When the gripper drive motor 132 is operated, the gripper fingers 138 can be moved to grip or release a vial 11. Gripper body 134 can have a gripper body pivot 136 that can be rotatably supported adjacent the remote end of rotatable arm 65 and can have a gripper sprocket 137 attached to gripper body 134 or gripper body pivot 136. Rotatable arm 65 can be pivotally mounted to feed head frame 270 by rotatable arm drive shaft 125 and can have a gripper drive sprocket 126 connected to rotatable arm drive shaft 125 such that gripper body 134, and accordingly gripper 130, can remain in the horizontal position as rotatable arm 65 is rotated between the positions illustrated in FIGS. 9A, 9B and 9C. A gripper chain 127 can connect gripper sprocket 137 and gripper drive sprocket 126 to rotate gripper body 134 as rotatable arm 65 is rotated so that gripper body 134 can remain in the horizontal position as rotatable arm 65 is rotated between the positions illustrated in FIGS. 9A, 9B and 9C. Gripper 130 can have an absolute encoder 129 that can be arranged to monitor the position of gripper fingers 138 and communicate the position of gripper fingers 138 to the control board 300 for gripper drive motor 132 for communication to controller 265. Gripper 130 can also have a gripper bar code reader 128 that can be connected to the control board 300 for the gripper drive motor 132 for connection to controller 265.

As shown in FIGS. 9A, 9B and 9C, when rotatable arm 65 is horizontal (rotatable arm 65 positioned at 90 degrees or 270 degrees with 0 degrees being straight down) and vial transport module 35 is properly positioned adjacent a vial feed module 90, gripper 130 when directed by controller 265 and the microprocessor 285 for gripper drive motor 132 can cause gripper drive motor 132 to drive gripper fingers 138 to engage a vial 11 from a labeler module 200 connected to a vial feed module 90. A vial feed module 90 can be provided on both sides of pill dispensing apparatus 10 (see FIG. 3), as described below. When rotatable arm 65 is pointed straight down (0 degrees), with vial transport module 35 properly positioned, gripper 130 can place a vial 11 in a feed position adjacent a selected dispensing unit 40. When rotatable arm 65 is pointing straight up (180 degrees), with the vial transport module 35 properly positioned, gripper 130 can place a vial 11 in a specific smart tote 30.

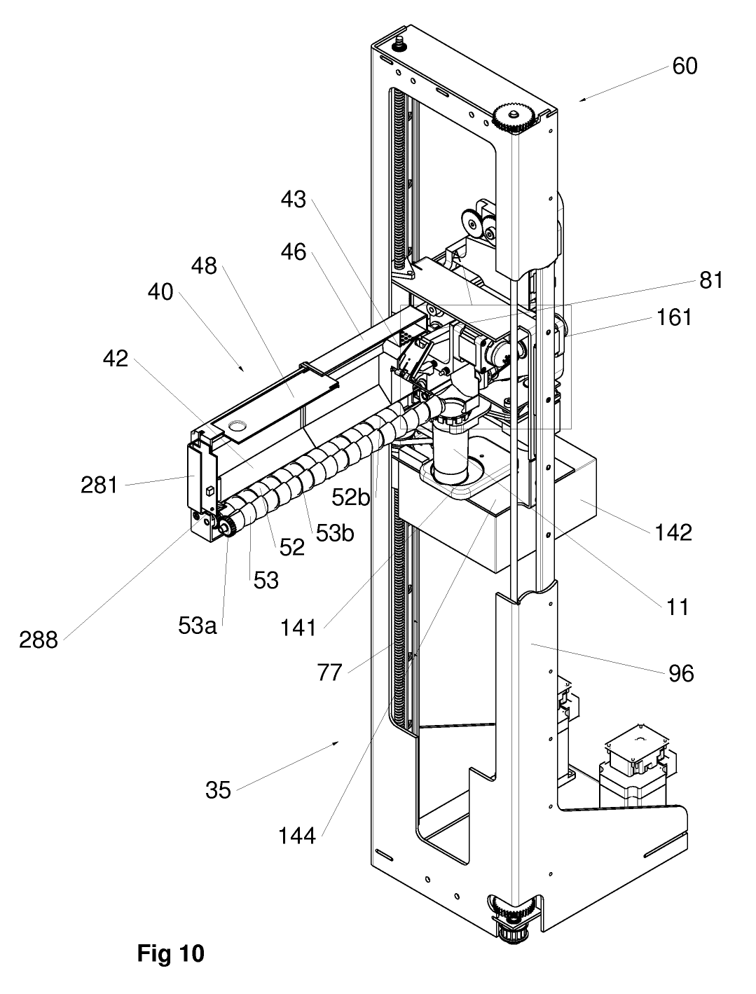

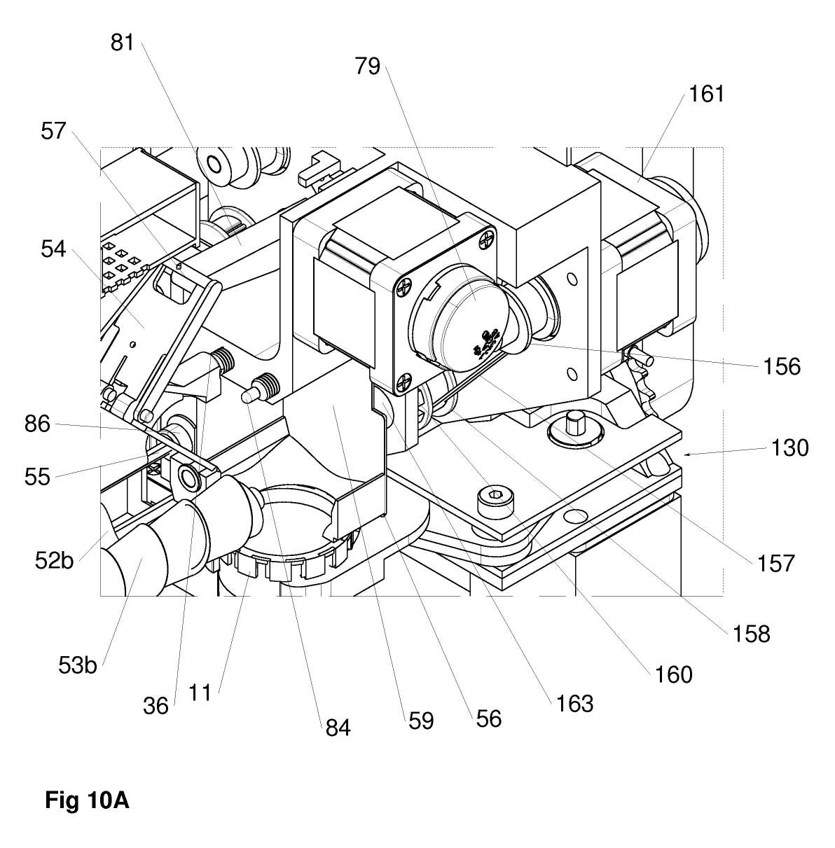

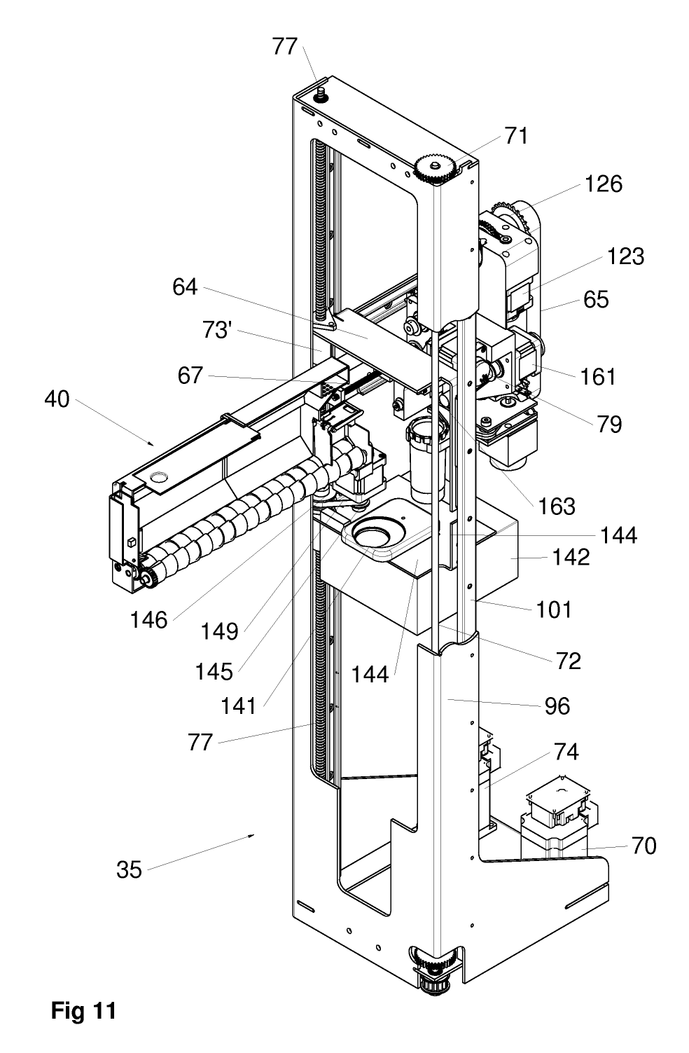

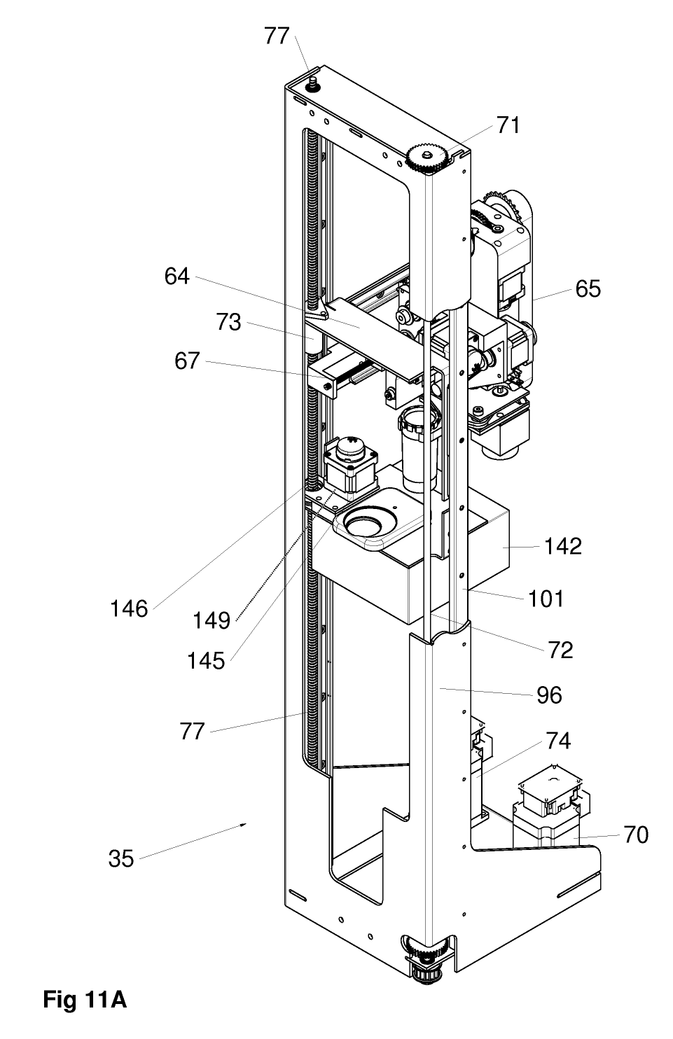

Referring to FIGS. 7A, 10 and 10A when vial transport module 35 has positioned feed head 60 behind a storage location 118 housing the selected dispensing unit 40, the z-direction drive motor 66, when directed by controller 265 and the control board 300 for the z-direction drive motor 66 including a microprocessor 285 that can be carried on a circuit board 286, not visible, that can be similar to the typical control board 300 illustrated in FIG. 17, can advance feed head 60 carrying an empty vial 11 toward the selected dispensing unit 40. A scale 142 can be supported on retriever frame 96 by a scale mounting bracket 144 that can be vertically movable in the y-direction along y-direction rail 101 below feed head module 60 and can have a scale pad 141 positioned on the top surface of scale 142. Scale mounting bracket 144 can have a plurality of bearing wheels 64” that can support scale 142 on y-direction rail 101. A scale stepper motor or actuator 143 can be mounted to a scale mounting bracket 144 and can include a scale drive pulley 145. Scale motor 143 can include a control board 300 including a microprocessor 285 that can be carried on a circuit board 286, not visible, that can be similar to the typical control board 300 illustrated in FIG. 17. A scale driven pulley 146 connected to scale drive nut 147 can be rotatably mounted to scale mounting bracket 144 engaging the y-direction drive screw 77 rotatably carried by the retriever frame 96. The scale drive pulley 145 can be connected to the scale driven pulley 146 with a scale drive belt 149. When y-direction drive servomotor 74 is operated to position feed head module 60 vertically by rotating y-direction drive screw 77, scale mounting bracket 144 can also be vertically positioned adjacent feed head module 60 as shown in FIGS. 10 and 11. Since scale drive nut 147 is not driven when y-direction drive screw is rotated, scale mounting bracket 144 to which scale drive nut 147 is mounted causes scale mounting bracket 144 to move along y-direction drive screw 77 in position adjacent feed head module 60. Further, when scale stepper motor 143 is operated scale driven pulley 146 can rotate scale drive nut 147 to adjust the position of scale mounting bracket 144 relative to feed head module 60. When the scale motor 143 is operated when directed by controller 265 and the microprocessor 285 for scale motor 143, scale 142 can be moved vertically to a selected height position to bring the scale pad 141 up under a vial 11 supported by gripper fingers 138 (see FIG. 10). The gripper fingers 138 can then be operated by gripper drive motor 132 as described above such that the gripper fingers 138 can release the vial 11 and no longer contact it allowing vial 11 to rest on scale pad 141. Scale 142 can verify the weight of the vial 11 to assure that it is empty. Scale 142 can then be zeroed to prepare for counting the feed of pills into vial 11. After dispensing pills into the vial 11 is complete the gripper fingers 138 can re-engage vial 11 and scale 142 can be lowered to allow feed head module 60 to move the filled vial 11 as will be described in detail below.

Referring to FIGS. 7, 7A, 10 and 10A feed head module 60 can include alignment pins 84 that can engage alignment holes 36 on dispensing units 40 as feed head module 60 is advanced in the z-direction to engage a dispensing unit 40 to assure dispensing unit 40 is properly aligned with feed head module 60 for a dispensing operation as will be described below. Feed head module 60 can further include an operator for funnel drawer 56 that can include an actuator motor 161 for extending and retracting an actuator screw 160. Actuator motor 161 can include a control board 300 including a microprocessor 285 that can be carried on a circuit board 286, not visible, that can be similar to the typical control board 300 illustrated in FIG. 17. Actuator motor 161 can have a driven pulley 156 connected by actuator drive belt 157 to a captured pulley/drive nut 158 carried on actuator screw 160. Actuator screw 160 can have an anti-rotate feature so that as captured pulley/drive nut 158 is rotated actuator screw 160 can advance or retract. The distal end of actuator screw 160 can be provided with an electromagnet 163 that can be electrically energized to magnetically couple actuator screw 160 to a coupler plate 59 on the face of a dispensing unit funnel 56 by controller 265 and the actuator motor 161 microprocessor. The actuator screw 160 can be extended by operating actuator motor 161 when directed by controller 265 and the microprocessor 285 for actuator motor 161. When extended, electromagnet 163 can abut and magnetically attach to coupler plate 59 on the selected dispensing unit funnel drawer 56. Actuator screw 160 can then be retracted by the actuator motor 161 under control of the controller 265 and actuator motor 161 microprocessor 285 to pull funnel drawer 56 to an “open” position as shown in FIG. 10. After pills are dispensed, as will be described below, funnel drawer 56 can be moved to a “closed” position by again operating actuator screw 160 to push funnel drawer 56 closed, de-activating electromagnet 163 and retracting actuator screw 160, all under control of the controller 265 and the microprocessor 285 for actuator motor 161 as described above. Next, gripper fingers 138 can be operated by gripper drive motor 132 as described above such that the gripper fingers 138 re-engage vial 11 and scale 142 can be lowered to allow feed head module 60 to be retracted in the z-direction to allow rotatable arm 65 to be rotated to the “safe position” to allow vial transport module 35 to move to a position for feed head module 60 to place the filled vial 11 in the proper smart tote 30.

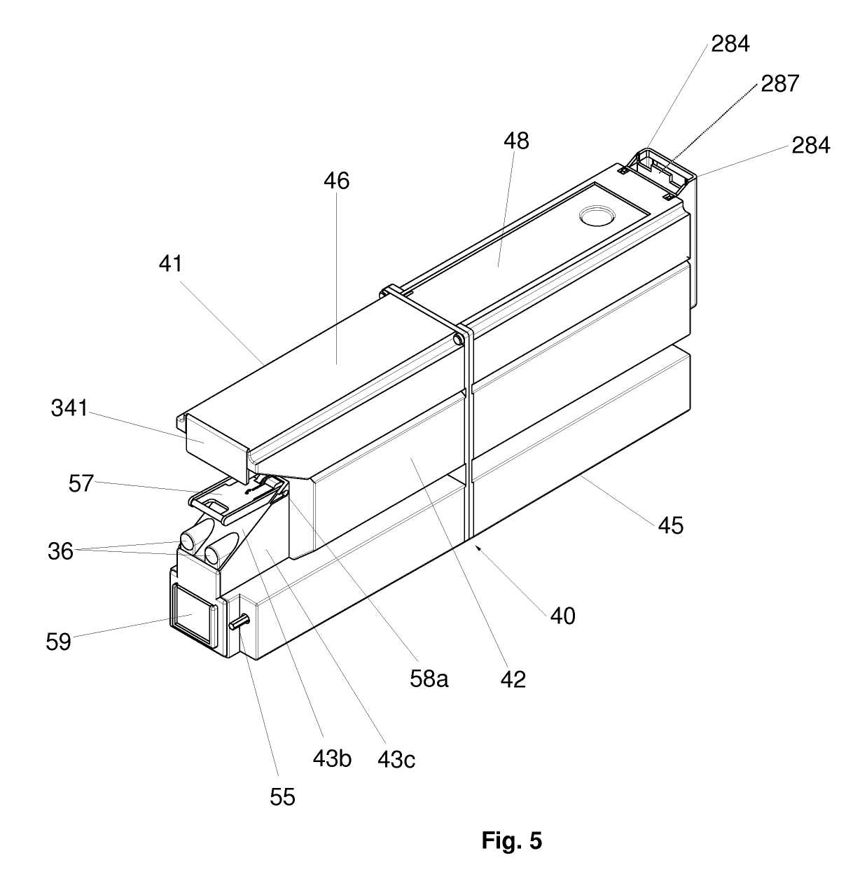

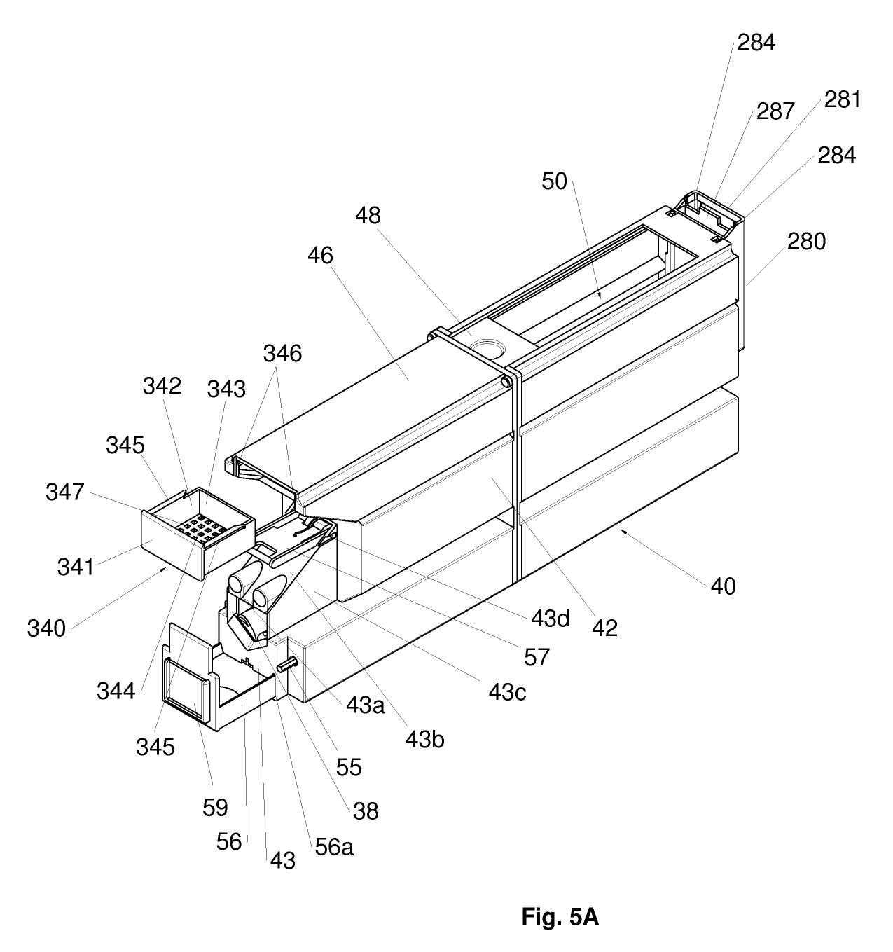

Referring to FIGS. 5, 6 and 10, as noted above, dispensing units 40 can include a generally rectangular container 41, rollers 52 and 53 positioned along the bottom wall 45 of container 41, a pill gate 54 movably positioned in container 41 for pivotal movement toward and away from the rollers 52 and 53, and a funnel drawer 56 to open and close an outlet opening 38 in container 41 with flat plate 51.

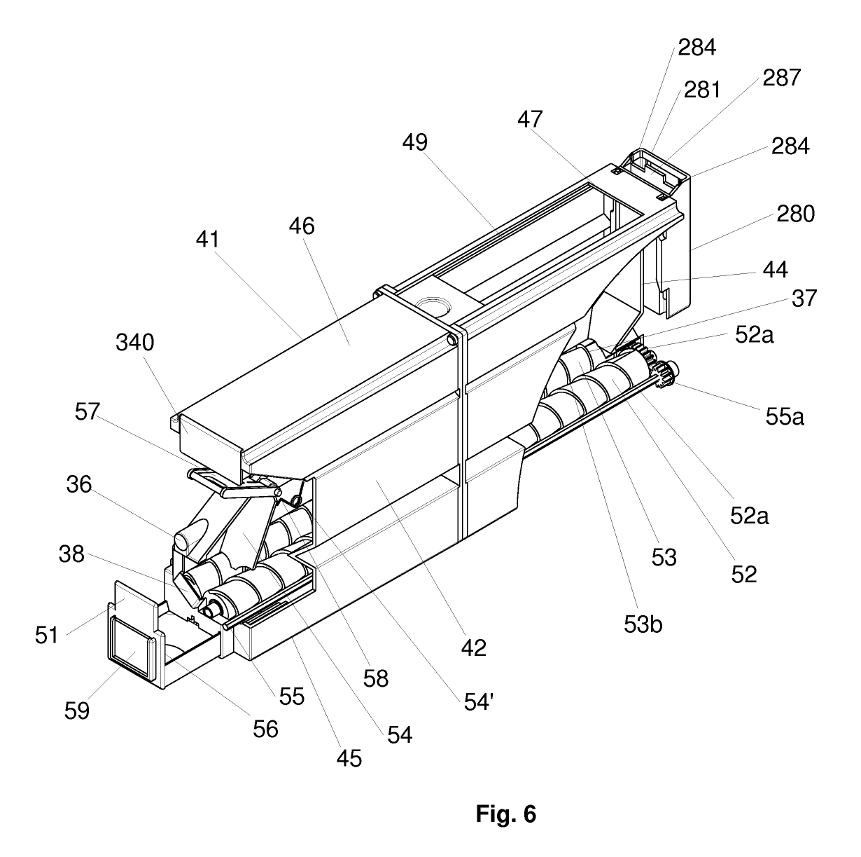

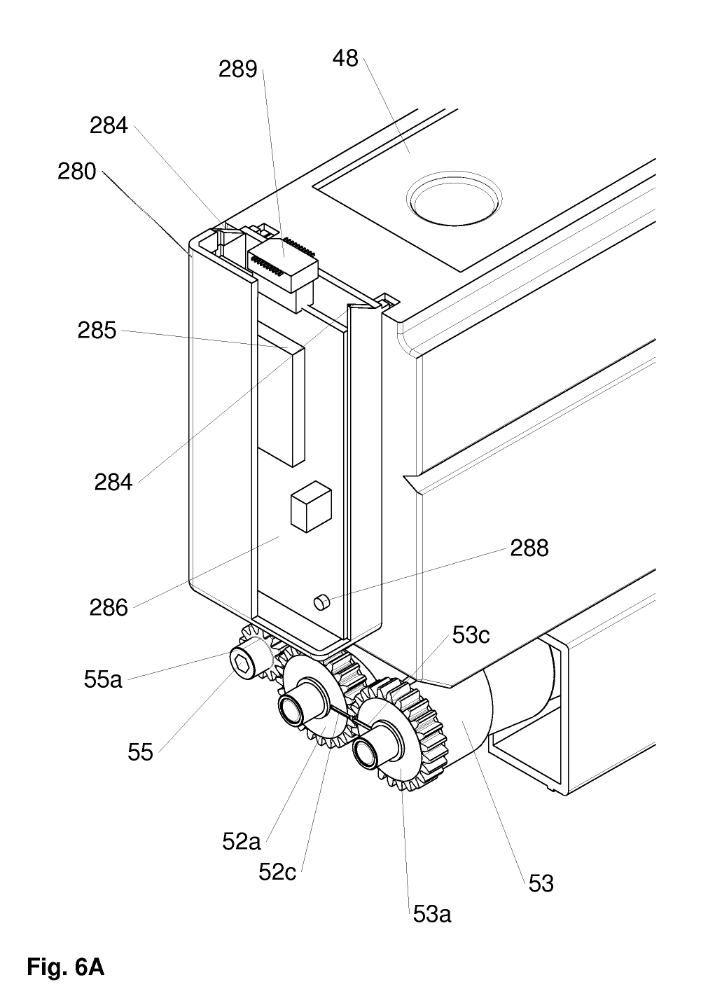

Referring to FIGS. 5, 5A, 6, 7A and 10A the container 41 for dispensing unit 40 can include generally flat sidewalls 42, a front wall 43, a rear wall 44, a partial top wall 46, and a bottom wall 45 forming a generally box-like container 41. Dispensing unit 40 can have a dispensing unit latch 280 carried on the rear wall of dispensing unit 40. Dispensing unit latch 280 can be vertically slidable on the rear of dispensing unit 40 and can be spring biased upwardly by springs, not visible. Dispensing unit latch 280 can also have latch surfaces 284 on opposite sides of the top surface 281 of dispensing unit latch 284. Latch surfaces 284 can engage a portion of matrix frame 105 that can extend along the front surface of each row of matrix frame 105. Latch surfaces 284 can physically secure a dispensing unit 40 in a storage location 118. Further, dispensing unit latch 280 can support a circuit board 286 that can include a microprocessor 285, one or more indicator lights 288 that will be described in greater detail below. Circuit board 286 can include a connector surface 287 at its top edge that can engage a connector 289. An array of connectors 289 can be provided adjacent the top of each row of storage locations 118 so that a dispensing unit 40 placed in any storage location can be connected to PCM 260 to provide connection between the respective dispensing units 40 and controller 265. Dispensing unit 40 can include a rectangular top opening 47 for loading pills, a top cover 48 which can slide in slots 49 that can run along the length of the top of sidewalls 42 that can close top opening 47. Top cover 48 can create a partially sealed dust-free pill chamber 50 for holding pills in bulk quantities. As noted above a desiccant drawer 340 can be provided adjacent top wall 46 in front wall 43 with perforate bottom wall 344 having a plurality of openings in bottom wall 344 that can provide communication with pill chamber 50 so that desiccant material, not shown, in desiccant drawer 340 can help keep pills in pill chamber dry. Front wall 43 can have a first portion 43a extending downwardly at an angle toward the rear of container 41, a second portion 43b extending downwardly at an angle forward toward the front of container 41 and side portions 43c extending downwardly from portion 43b toward the bottom of container 41. Thus, front wall 43 including first portion 43a, second portion 43b an side portions 43c can form a tapered cavity that can narrow to the width of rollers 52, 53 at the front of container 41. Front wall 43 can define an outlet opening 38 that can extend between side portions 43c and from second portion 43b to the top surface of rollers 52, 53. Outlet opening 38 can have a “V” shaped bottom surface that can generally parallel the top surface of rollers 52, and 53 that can direct pills moved along the top surface of rollers 52 and 53 into funnel drawer 56 below outlet opening 38. Side portions 43c can have pivot holes 58a formed adjacent to top edge of second portion 43b. Pill gate 54 can be pivotally attached to front wall 43 by pivot 58 at pivot holes 58a. Pill gate 54 can be spring-biased downwardly by a gate spring 54′ that can be arranged to bias pill gate 54 downwardly to a “closed” position adjacent rollers 52 and 53. The upper end of the pill gate 54 can extend outward through front wall slot 43d adjacent the top edge of second portion 43b, and can include an exposed tab 57 that can extend through front wall slot 43d. Tab 57 can be engaged by an actuator finger 81 that can be operated by a gate stepper-motor or actuator 79 carried on feed head 60 that can lift pill gate 54 to allow pills to pass under pill gate 54 when rollers 52 and 53 are operated and allow pills to drop off the rollers through outlet opening 38 and funnel drawer 56 into a vial 11 positioned under funnel drawer 56. Actuator finger 81 can be attached to the shaft of gate stepper-motor 79 and can be positioned by operating gate stepper motor 79. Gate stepper motor 79 can include a control board 300 including a microprocessor 285 that can be carried on a circuit board 286, not visible, that can be similar to the typical control board 300 illustrated in FIG. 17. Gate stepper motor 79 can be operated under control of controller 265 and the gate stepper motor microprocessor 285 to operate actuator finger 81 to lift tab 57 to rotate pill gate 54 to lift the bottom edge of pill gate 54 away from rollers 52, 53 so that more pills can flow under pill gate 54 to the outlet opening 38. Funnel drawer 56 can slide in slots 56a that can be provided adjacent the bottom of sidewalls 42 adjacent front wall 43. Funnel drawer 56 can help create a partially sealed dust-free environment in the closed position with flat plate 51 closing outlet 38 for holding pills in bulk quantities and can provide a generally funnel shaped surface as illustrated in FIG. 6 to direct pills as they drop from the rollers 52 and 53 through outlet 38 into a vial 11.

An important aspect of the funnel drawer 56 is that, when the funnel drawer 56 is in a near-closed position, a flat panel 51 that can be carried on the front edge of funnel drawer 56 above coupler plate 59 can move in a direction substantially parallel to the axis of rollers 52 and 53. Flat panel 51 can cause any pills (not shown) that might be hanging on an edge of rollers 52 and 53 that have not yet fallen through outlet opening 38 (pills which are ready to fall but that have not yet quite fallen) to be pushed back onto rollers 52 and 53 as funnel drawer 56 is closed. Flat panel 51 can help avoid problems in prior art dispensers caused by pills hanging on an edge of the pill feeding system. Specifically, in prior art dispensers “hanging” pills can drop after the operation of counting pills has stopped resulting in “extra” pills being dispensed, and, in effect, given away for free. Alternatively, “hanging” pills can potentially get caught in a dispensing door such that the pill can hold the door partially open. Further, some dispensing doors can crush a “hanging” pill, causing debris problems, sanitation or cross-mixing problems, and other related problems. The dispensing unit 40 according to the invention solves the “hanging pill” problem by flat panel 51 pushing any “hanging” pills back onto rollers 52 and 53, so that the potentially “hanging” pill is held within the pill chamber 50 in a sanitary and sealed environment. In the fully closed position, the flat panel 51 can sit flat against the front wall 43 of the container 41 closing outlet opening 38.

In some prior art pill dispensing systems, separate pieces defining different sizes and shapes of “gaps” were sold by the manufacturer in order to optimize their pill-dispensing systems. However, this approach to counting pills resulted in a myriad of additional special-order custom-built parts and pieces. While this may be beneficial to the manufacturer of the pill-dispensing equipment due to increased reordering of specialty parts and pieces, use of separate “gap” parts can cause a major problem for users, since the users “never” seemed to have the right mix of “gap” parts that they needed to adapt the pill-dispensing system to a new pill. As a result, users continually had to order new and different parts and pieces from the manufacturer adding considerably to cost and maintenance problems. The dispensing pill gate 54 used in dispensing unit 40 is very simple and easily selected, simple to use, intuitively logical in its application and flexibility of use, and easy to replace. Further, it uses a single pill gate 54 and simple attachment mechanism. Pills to be fed can be sized on a chart to determine the optimal “gap size” for drugs. Thus, recommended initial settings for the gate stepper motor 79 can be quickly and easily made. Controller 265 can have a drug database 254 that can store the optimal “gap size” for drugs in the system. For example, gap size for drugs can be “learned” starting from a “starting” gap size and feeding back fill information to adjust the fill parameters that can be stored in the drug database 254.

As can be seen in FIGS. 6, 6A and 10 the walls of the lower portion of the dispensing unit 40 can include inwardly angled sidewall portions 42, and rear wall portion 44 (see FIGS. 6 and 10). The angled rear wall 44 can define an opening 37 at its lower end just above the rollers 52 and 53. The angled portion of rear wall 44 can enclose the gears 52a and 53a on the ends of rollers 52 and 53 and gear 55a on the end of driver 55, such that the opening 37 located at the bottom of rear wall 44 just above the rollers 52 and 53 can prevent any pills from being crushed or damaged in the gears 52a, 53a or 55a. Gears 52a and 53a can have timing marks, 52c and 53c that can allow rollers 52 and 53 to be properly positioned so that helical ridges 52b and 53b properly cooperate to advance pills toward outlet 38 when dispensing unit 40 is operated by the feed head module 60.

As noted above, the rollers 52, 53 can be positioned along the bottom wall 45 of container 41. Rollers 52 and 53 can be designed for feeding solid pills along their length upon rotation of the rollers 52, 53. The rollers can made of a solid polymeric block member and can include a spiral or helical ridge or groove 52a, 53a to engage pills as the rollers 52 and 53 rotate. Rollers 52, 53, when rotated, move the pills, tablets, capsules in container 41 toward outlet 38 into a vial 11. The dispensing unit 40 can contain pills to be dispensed and the pills in container 41 can rest on the two tangent rollers 52, 53, that can be rotated to move pills in the container 41 toward outlet 38. The dispensing unit 40 can be internally designed to store a variety of pill shapes and sizes. Rollers 52 and 53 can have helical ridges 53b and 53b formed on the exterior surface and can be molded from a variety of materials such as Delrin® or machined from stock material. Further, the roller gears 52a, 53a may be individually molded and attached to the upstream end of the rollers 52, 53 or the gears 52a, 53a may be integrally molded as part of the end of the roller.

Rollers 52 and 53 can be tangent along their length roughly-defining a “V” shape. Helical ridges 53b and 53b can be wound opposite directions around rollers 52 and 53 and timed, using timing marks 52c and 53c, such that the alignment of the helical ridges 53b and 53b can define a series of moving pockets at the intersection of rollers 52 and 53 that, as rollers 52 and 53 are rotated, can convey pills toward to front wall 43 of container 41. Rollers 52 and 53 can be rotated in opposite directions so that each roller 52 and 53 rotates with the top surfaces of the respective rollers 52 and 53 moving away from the adjacent roller so that pills are not caught between the rollers 52 and 53 and potentially crushed. The pill gate 54 can be positioned adjacent rollers 52 and 53 prior to outlet opening 38 and can block pills above pills engaged by rollers 52 and 53 and can thus provide a single stream of pills traveling downstream to the outlet. Notably, the gap between the rollers 52 and 53 can be open to allow degradation and “dust” from abraded pills and/or from bulk supply containers to fall through rollers 52, 53 such that sanitation and cleanliness is improved.

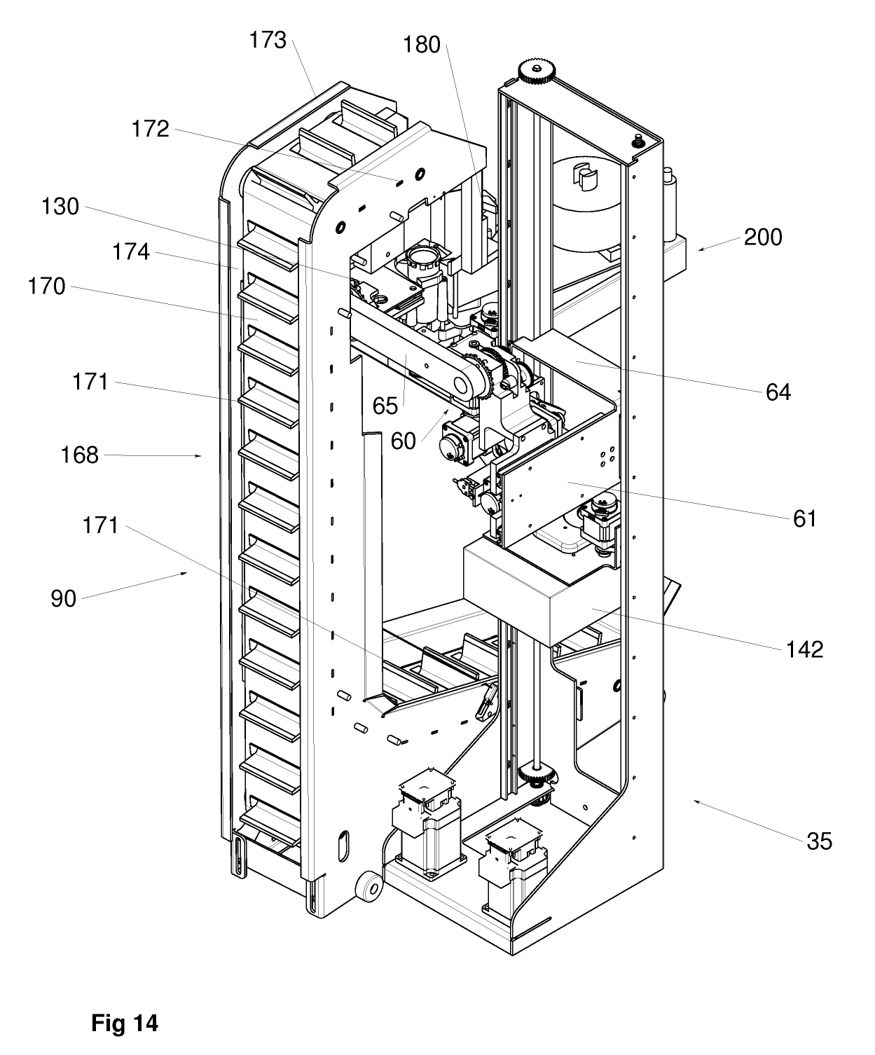

Referring to FIGS. 3, 14 and 14A, vial handling devices are well known in the art such that a detailed description is not required. Accordingly, the discussion below is sufficient for an understanding of the present inventive concepts by persons skilled in the art. A vial feed module 90 can be provided on each end of pill dispensing apparatus 10 and each vial feed module 90 can be positioned in a vial storage bin 175. Each vial storage bin 175 can have a tilt out front closure 176 that can facilitate refilling the respective vial storage bins 175. Vial feed modules 90 can include a vial conveyor 168 that can have a vial conveyor belt 170 that can have cleats 171 that can be shaped to hold vials 11. Vial conveyor belt 170 can be driven upwardly in vial storage bin 175 along the front surface 169 of vial conveyor 168 from the lower section of vial storage bin 175 moving through the bottom of the bulk supply of vials 11 and vertically up to the head 172 of vial conveyor 168 along the rear wall (not visible) of vial storage bin 175. Vials that do not seat fully into a cleat 171, can fall off the vial conveyor belt 170 as vial conveyor belt 170 changes direction to vertical. Vials 11 that successfully seat and are conveyed to the head 172 of the vial conveyor 168 can “fall off” vial conveyor belt 170 into vial uprighter unit 180. An advantage of providing two vial feed modules 90 and vial storage bins 175 is the capability of storing and dispensing pills into two different size vials 11, for example 16 dram vials can be stored on one end and 40 dram vials can be stored on the other end of pill dispensing apparatus 10. Those skilled in the art will appreciate the vial feed modules 90 and vial storage bins 175 can be sized to store vials of any desired size and that if desired both storage bins 175 can store the same size vial if that is desired by the pharmacy. Referring to FIG. 14A vial conveyor 168 can include a plurality of conveyor belt edge rollers 165 that can engage the edges of conveyor belt 170 and can conveyor direct belt 170 upwardly and, and adjacent top 170, forwardly toward uprighter module 180. Conveyor 168 can include a driven pulley/front roller 197, top rollers 199 and tension roller 198 that can guide and drive conveyor belt 170. Conveyor 168 can include a drive motor 194, adjustable motor bracket 195 and drive belt 196 to drive driven pulley/front roller 197 to cause conveyor belt 170 rotate through vial storage bin 175 to carry vials 11 to uprighter module 180. Drive motor 194 can include a control board 300 including a microprocessor 285 that can be carried on a circuit board 286, not visible, that can be similar to the typical control board 300 illustrated in FIG. 17. Vial conveyor 168 can also include one or more level switches 177 that can be connected to controller 265 to enable controller 265 to indicate when supply of vials 11 in a storage bin 175 is low.

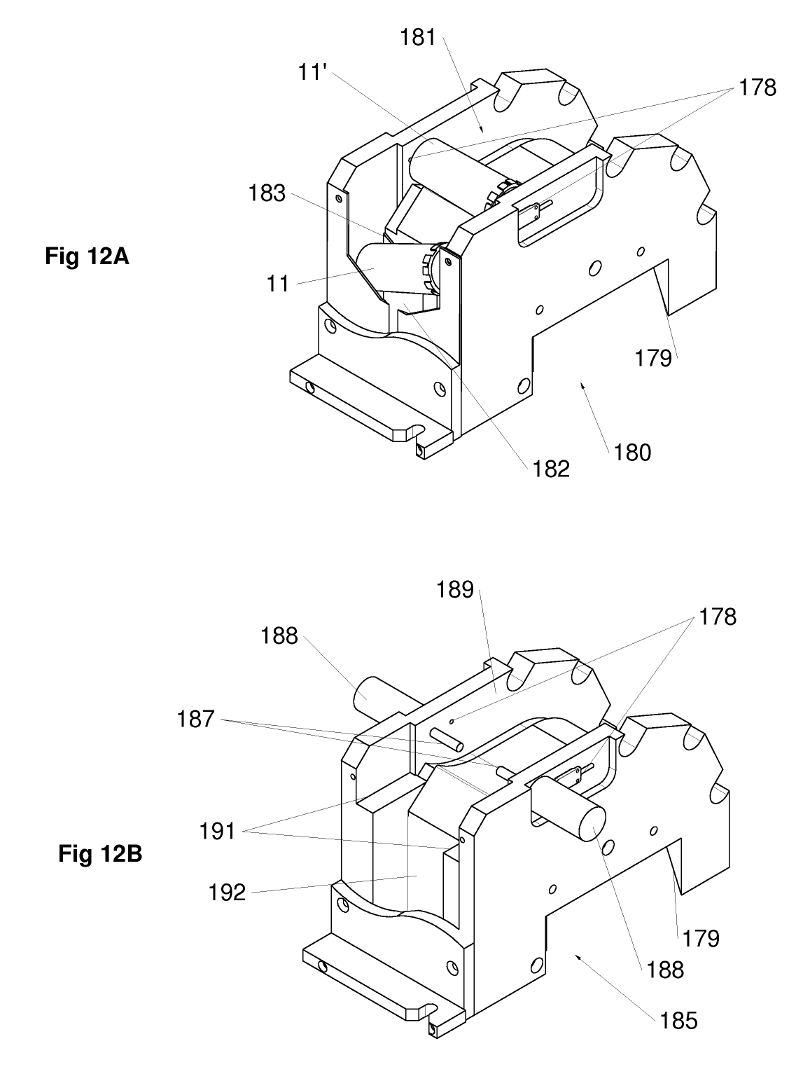

Referring to FIGS. 3, 12a, and 14A vial conveyor belt 170 can travel upward along the upright portion 167 of vial conveyor 168. When vial conveyor 170 reaches head 172 a wall, not visible, can be positioned along the lower surface of head 172 and can retain vials 11 between cleats 171 on conveyor belt 170 as conveyor belt 170 is directed forward by conveyor belt rollers 165 as noted above. As conveyer belt 170 reaches the front of head 172 conveyor belt 170 can be directed upwardly to the top 173 of head 172 and then rearwardly to the rear surface 174 of conveyor 168 by top rollers 199 to return to the bottom of storage bin 175. As vials 11 on conveyor belt 170 reach the front of head 172 vials 11 can enter an uprighter 180 passing cam surfaces 179 that can be provided on each side of uprighter 180 to center vials 11 in uprighter 180. When vials reach the position illustrated by the upper vial 11′ in FIG. 12A after it has fallen off the conveyor belt 170, the vial 11′ will remain in that position as the base of uprighter chamber 181 is “uphill” so that a vial 11′ in that position will not move into outlet 182 until the next vial 11 falling off conveyor belt 170 pushes the vial into outlet 182. As successive vials 11 “fall off” conveyor belt 170 into vial uprighter unit 180 the vials 11 can sequentially enter an uprighter chamber 181 that can receive vials 11 from conveyor belt 170 after the vials 11 pass through cam surfaces 179 and are centered. As vials 11 are pushed through uprighter camber 181 the vial 11′ at the front of uprighter 180 can fall into outlet 182. As vials 11 fall into outlet 182 funneling ridges 183 on the vertical walls of outlet 182 can engage the ears typically included at the top, open end, of vials 11 as the vial drops into outlet 182 so that the bottom of vial 11 is down and the open end of vial 11 is up. Uprighter unit 180 includes a funneling protrusion or ridge 183 that can engage the ears typically included at the top, open end of vials 11 as they move into uprighter chamber 181 and fall into outlet 182. The bottom of vial 11 being narrower than the ridges at the top of vials 11 can fall through the funneling ridges 183 since the ears on the top of the vials 11 engage the funneling ridges 183 causing the bottom end of vials 11 to naturally swing downwardly ahead of the top of vials 11 in outlet 182. The funneling ridges 183 can angle down and can have a center gap of sufficient size so the ears on the top of vials 11 can pass through outlet 182 and allow vial 11 to drop through uprighter chamber 182 now oriented open top up into the labeler module 200. Uprighter 180 can also have a pair of optic switches 178 on opposite sides of uprighter chamber 181 that can detect the presence of a vial 11. When a vial 11 does not occupy uprighter chamber 181, conveyor belt drive motor 194 can be operated by controller 265 and conveyor belt drive motor 194 until a vial 11 is pushed into place, illustrated by vial 11′ and optic switches 178 are operated by vial 11′ interrupting the light beam between optic switches 178.

Different uprighters are known in the art. Referring to FIG. 12b, an alternate uprighter module 185 can be seen. Alternate uprighter module 185 can have cam surfaces 179 that can center a vial on conveyor belt 170 approaching uprighter module 185 as described above. Similar to uprighter module 180, uprighter module 185 can include optic switches 178 that can be used to control operation of conveyor belt drive motor 194 as described above. Alternate uprighter module 185, instead of catching protrusions on a funneling ridge 183 is arranged to advance fingers 187 toward a horizontally staged vial 11 located in an uprighter chamber 189 such that the finger 187 on one side can pass into the open end of a vial 11 and the other finger 187 can advance and contact the bottom wall of a vial 11 and push it such that the open end of vial 11 can rest on support ledge 191. Fingers 187 can be operated by solenoids 188 under control of controller 265 and can be operated when a vial 11 is detected by optic switches 173. Then as vial 11 is released it can drop bottom (closed) end first uprighting vial 11 and dropping it into outlet 192 and through outlet 192 into labeler module 200. In operation vial feed module 90 can operate to drop a vial 11 into labeler module 200 in order to apply a prescription label on a vial 11 prior to the pill dispensing apparatus filling the vial 11 with pills for that prescription as will be described below.

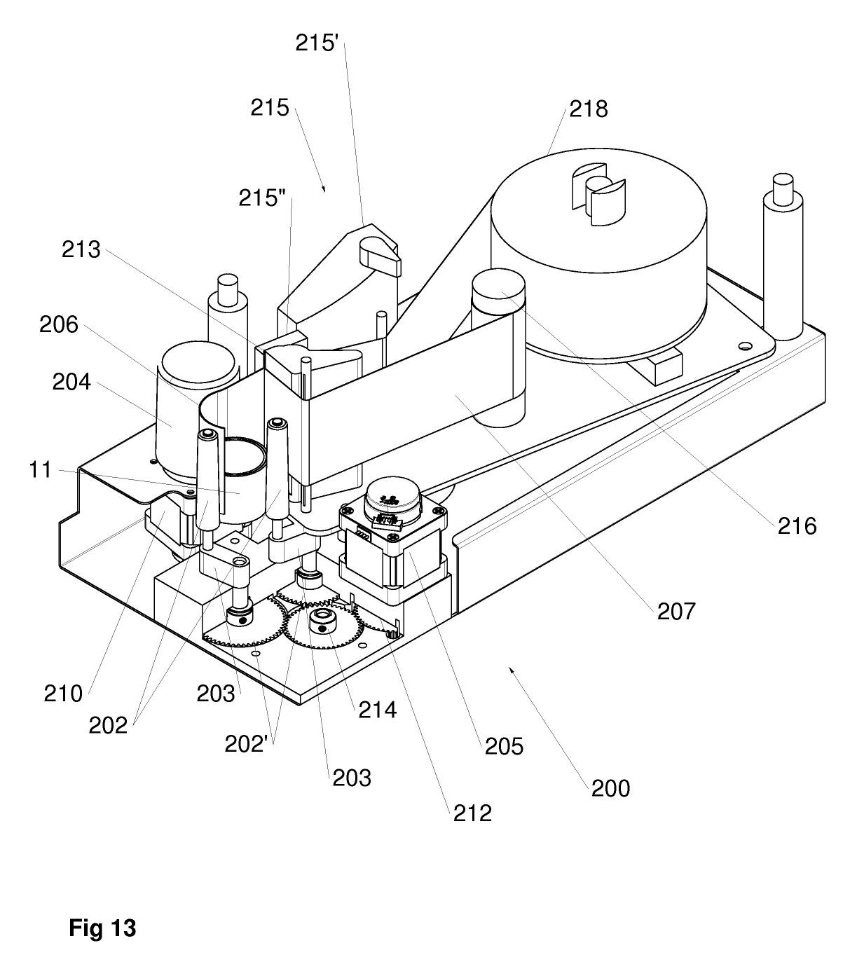

Referring to FIGS. 3, 13 and 15, labeling of a vial 11 can be seen. Vial feed module 90 can include a labeler module 200. As illustrated in FIGS. 1-3, pill dispensing apparatus 10 can have two storage bins 175 for vials 11 and can have two vial feed modules 90 that can allow a pharmacy or other user to stock, and selectively dispense two sizes of vials 11, for example 30 day supply prescriptions and 90 day supply prescriptions or prescriptions for small pills and for larger pills without using a “too big” vial for many prescriptions. As described above, a vial 11 can be dropped into the labeler module 200 between pressure rollers 202 and drive roller 204 by an uprighter module, for example uprighter module 180 or 185. In FIG. 13 the top portion of vial 11 has been removed in order to illustrate a label being applied to vial 11. Pressure rollers 202 can rotate in a horizontal arc as a result of offset 203 in axis of pressure rollers 202 from the axis of pressure roller gears 202′. Pressure rollers 202 can be positioned by pressure roller gears 202′ to engage the side surface of a vial 11 positioned in the labeler module 200. Pressure rollers 202 can be operated by pressure roller gears 202′ by drive gear 212 and pressure roller stepper motor 205 via intermediate gear 214. Pressure roller stepper motor 205 can include a control board 300 including a microprocessor 285 that can be carried on a circuit board 286, not visible, that can be similar to the typical control board 300 illustrated in FIG. 17. Pressure roller stepper motor 205 can be operated under control of the pressure roller stepper motor microprocessor 285 to rotate pressure rollers 202 into contact with vial 11. Drive roller 204 can be rotated by a drive roller stepper motor 210 that can include a control board 300 including a microprocessor 285 that can be carried on a circuit board 286, not visible, that can be similar to the typical control board 300 illustrated in FIG. 17. Drive roller stepper motor 210 can be operated under control of the controller 265 and driver roller stepper motor 210 microprocessor 285 to rotate a vial 11 in the labeler module 200. An adjacent printer 215 can print the patient's information as supplied by the pharmacy computer 22 to the order database 252 associated with controller 265. Printer 215 can be a direct thermal printer having print head assembly 215′ that can include a direct thermal print head 215″. A roll of self adhesive labels 206 on a backing strip 207 can be routed through printer 215 from a supply roll 218. As labels 206 exit print head 215″ the backing strip 207 can be pulled over a corner 213 causing the label 206 to separate from the releasable paper backing strip 207 as label 206 passes corner 213 so that label 206 can be positioned with the sticky side facing a vial 11 and, as it extends into the tangent point between drive roller 204 and vial 11, the label 206 can contact vial 11 and adhere to the surface of vial 11 as the vial 11 is rotated by drive roller 204. Pressure rollers 202 can press vial 11 into contact with drive roller 204 with label 206 between vial 11 and drive roller 204 to press the printed label 206 into adhering contact with the side surface of the vial 11 as vial 11 is rotated. The backing strip 207 can wind up on take up roller 216 that can be spaced adjacent supply roller 218. Pressure rollers 202 and offsets 203 can be arranged so that labeler module 200 can accommodate a variety of sizes of vials 11 since pressure rollers advance toward a vial 11 in an arc determined by the offset 203.

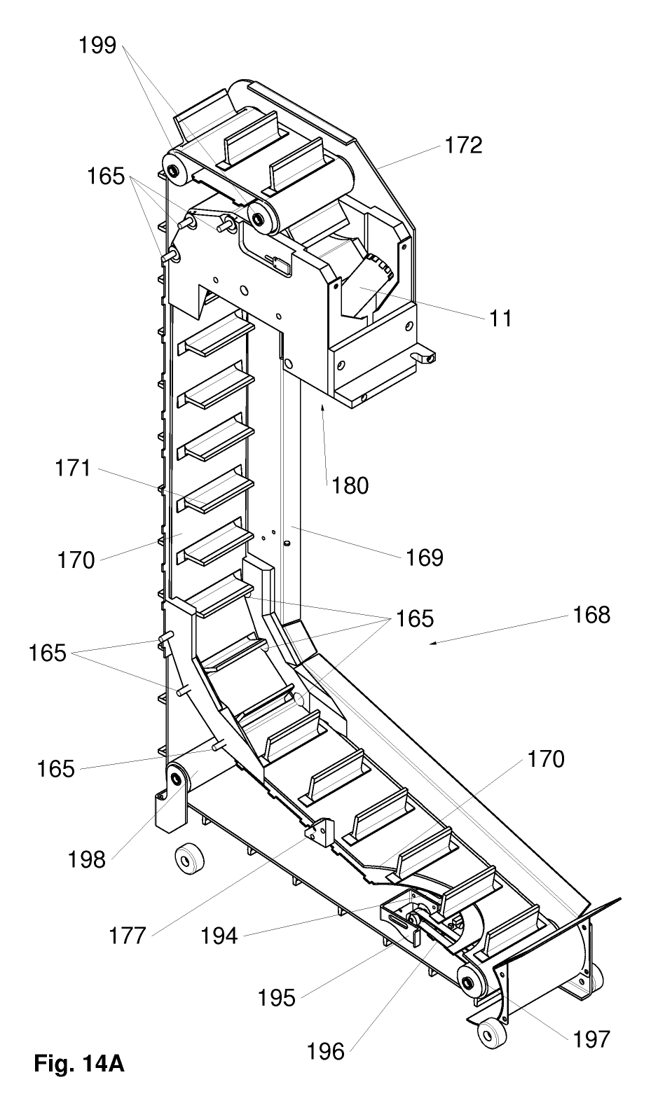

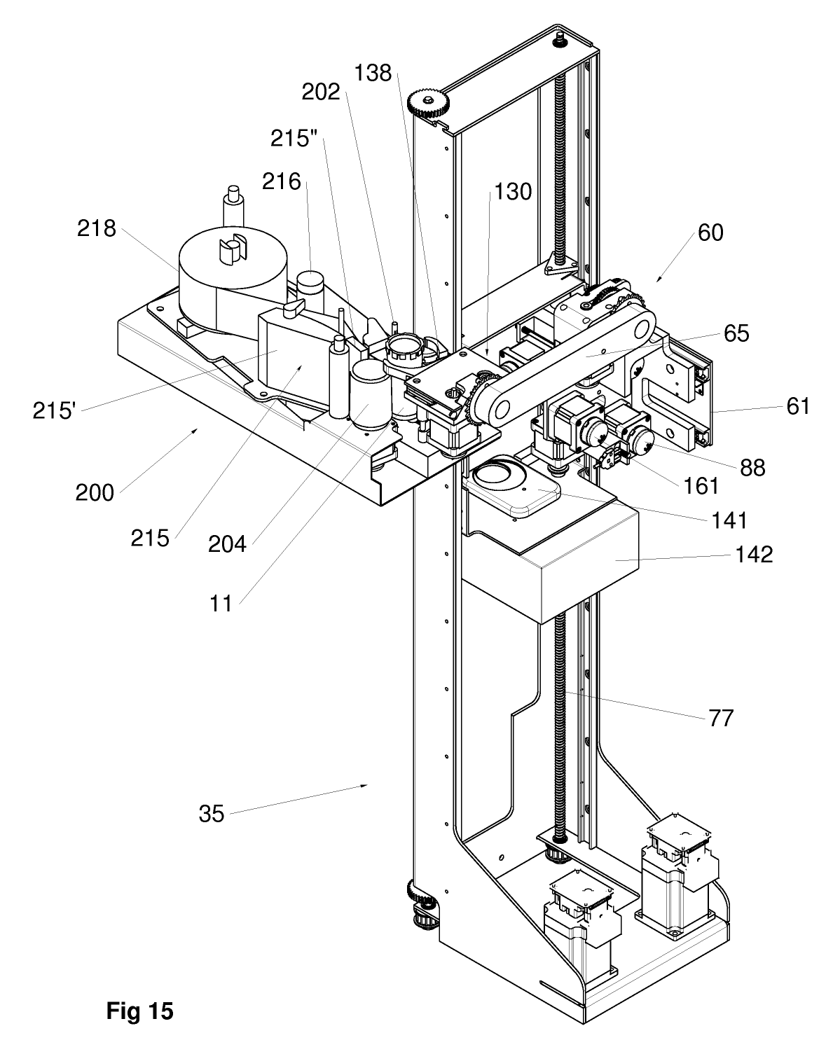

When a label 206 has been printed and applied to a vial 11, the feed head module 60 can be adjacent the labeler module 200 or returned to the labeler module 200 if vial transport module 35 has moved the feed head module 60 to a different location during the labeling of a vial 11. When feed head module 60 is positioned at a labeler module 200 (see FIG. 15) with a labeled vial 11, controller 265 can cause the gripper 130 to move to adjacent the labeled vial 11, (see FIG. 15). With gripper 130 located adjacent a labeled vial 11, a gripper bar code reader 128 that can be mounted to the gripper 130 (see FIG. 8) can read a barcode on the label 206 as the vial 11 with label 206 rotates at the gripper bar code reader 128. When the gripper bar code reader 128 completes the scan of label 206, controller 265 can signal the drive roller motor 210 to stop rotation of vial 11 and then rotation of vial 11 can be reversed halfway between where read started and stopped to position vial 11 with label 206 in a position to be again read at a dispensing unit 40. Gripper 130 can close gripper fingers 138 on vial 11 as described above. Once gripper fingers 138 have engaged vial 11, pressure rollers 202 can be opened by pressure roller stepper motor 205 releasing the vial 11, leaving gripper 130 holding the labeled vial 11. As printer rollers 202 move away from the vial 11 in an arc resulting from offsets 203 vial 11 can be removed from printer module 200 by feed head 60.

With the vial 11 gripped by gripper 130 controller 265 can cause the feed head module 60 to retract (in the “z” direction) on laterally extending arm 61 to move feed head module 60 away from vial transport module 90 and labeler module 200 and then rotate rotatable arm 65 to a “safe to move” position with the rotatable arm 65 rotated to the 0 degree position (see FIG. 9B). Controller 265 can then cause vial transport module 35 to position feed head module 60 in front of the dispensing unit 40 corresponding to the drug indicated on label 206 on the vial 11. Once again referring to FIGS. 10 and 10A, once controller 265 has positioned feed head module 60 in front of the appropriate dispensing unit 40, as described above, controller 265 can cause feed head module 60 to engage the selected dispensing unit 40. As feed head module 60 is advanced toward dispensing unit 40 tapered alignment pins 84 can engage alignment holes 36 in the front wall 43 of dispensing unit 40 to provide final positioning of the feed head module 60 to dispensing unit 40. Next controller 265 can cause rotational drive head 86 to engage driver 55 for rollers 52, 53. The rotational drive head 86 can be spring loaded, and if rotational drive head 86 fails to engage driver 55 as feed head module 60 is advanced toward dispensing unit 40, rotational drive head 86 can snap into engagement with driver 55 once rotation of rollers 52, 53 begins. Controller 265 can cause actuator motor 161 microprocessor 285 to operate actuator motor 161 to extend actuator screw 160 toward dispensing unit 40. With the feed head module 60 fully engaged with dispensing unit 40 the bar code reader 151 on feed head module 60 (see FIG. 7A) can scan the barcodes on the dispensing unit 40 and on vial 11 to verify a match before controller 265 and the actuator motor 161 microprocessor 285, not visible, cause opening the funnel drawer 56 on the dispensing unit 40 and commencing the dispensing operation. Dispensing unit 40 can have a bar code (not visible) on front wall 43 at a position where it can be scanned by bar code reader 151. Bar code scanner 151 can be positioned on feed head module 60 to be able to scan a vial held by gripper 130 adjacent the dispensing unit 40. Controller 265 can be programmed to verify the dispensing unit 40 bar code and verify the vial 11 bar code before opening the funnel drawer 56, and if desired, re-verify the vial 11 bar code prior to opening pill gate 54 and operating the rollers 52 and 53 to begin dispensing pills from the dispensing unit 40 into the vial 11.

Once a barcode match is verified, controller 265 can cause scale 142 to rise by operating scale motor 143 to cause scale 142 to rise toward feed head module 60 until scale pad 141 is lifted to the bottom of vial 11 as described above. Controller 265 can then cause gripper 130 to open gripper fingers 138 allowing vial 11 to rest on the scale pad 141 and then can continue to open gripper fingers 138 to eliminate any contact between the gripper fingers 138 and vial 11. Controller 265 can then verify that the weight of vial 11 is within the range for the weight of an empty vial 11 by communication with a microprocessor 285 that can be carried on a circuit board 286 associated with a scale interface control board 300, not visible, that can be similar to a control board 300 illustrated in FIG. 17 adapted for use with scale 142. If the vial 11 weight exceeds a predetermined amount, controller 265 can assume that the vial is not empty and controller 265 can cause the vial transport module 35 to place the vial 11 in an unassigned smart tote 30 and can cause the smart tote 30 to display the fault. Controller 265 can then restart the pill dispensing cycle and once a vial 11 verifies within the proper weight carrying a label 206 with the appropriate bar code by scanning the bar codes on the label 206 and the dispensing unit 40, the funnel drawer 56 on the dispensing unit 40 can be pulled open by operating actuator motor 161 to operate actuator screw 160 as described above under control of controller 265 and the actuator motor microprocessor 285. As actuator motor 161 operates actuator screw 160 can advance electromagnet 163 to engage steel plate 59 on the drawer funnel 56. Upon the actuator motor microprocessor 285 energizing the electromagnet, 163 actuator motor 161 can reverse and retract actuator screw 160 to pull funnel drawer 56 open.

Feed motor 88 can include a control board 300 including a microprocessor 285 that can be carried on a circuit board 286, not visible, that can be similar to the typical control board 300 illustrated in FIG. 17 and can be operably connected to rotational drive head 86. Referring to FIGS. 10 and 10A, with funnel drawer 56 open, controller 265 can cause the microprocessor 285 for feed motor 88 to operate to rotate the rollers 52, 53. The microprocessor 285 for gate stepper motor 79 can cause actuator finger 81 to engage tab 57 to rotate pill gate 54 to allow pills to pass under pill gate 54 and drop off rollers 52, 53 through outlet 38 into funnel drawer 56 into a vial 11. An adaptive closed loop control can be provided that can communicate with the scale 142 microprocessor 285 and controller 265, gate stepper motor 79 microprocessor 285 and feed motor 88 microprocessor 285 to control gate stepper motor 79 and feed motor 88 thereby controlling the position of gate 56 and the speed of rotation of rollers 52 and 53 to control the flow of pills being dispensed out of the dispensing unit 40. An adaptive closed loop control can cause controller 265 to raise and lower pill gate 54 via gate stepper motor 79 microprocessor 285 and the rotational speed of rollers 52 and 53 via the feed motor 88 microprocessor 285 as the vial 11 fills with pills and scale 142 monitors the weight of vial 11 and communicates via the scale interface microprocessor 285 to determine, based on information in the drug database 254, the weight of the number of pills to be dispensed into vial 11. Scale 142 can continue to monitor the weight of vial 11 as feed motor 88 is operated by the feed motor 88 microprocessor 285, and controller 265 can compare the weight of vial 11 and pills to the value stored in drug database 254. Controller 265 can, once the weight of vial 11 reaches a predetermined percentage of the final weight of the selected number of pills to be dispensed, stop feed motor 88 to stop rollers 52, 53 to allow scale 142 to stabilize so an exact quantity of pills dispensed so far can be determined. The quantity of pills dispensed so far can be subtracted from the quantity required to fill the prescription to obtain the remaining quantity to be dispensed. Controller 265 can then operate feed motor 88 and gate stepper motor 79 through a preprogrammed routine controlling both the pill gate 54 and the rotation of rollers 52, 53 to obtain one by one dispensing of pills through funnel drawer 56 into vial 11 via the respective microprocessors 285. Feed rollers 52 and 53 can be pulsed to “nudge” pills forward to shift pills toward outlet 38 to “nudge” pills off one by one into drawer funnel 56. An optic device (not shown) or impact readings on the scale 142 can detect and count pills being dropped until the final quantity of pills are dispensed. Controller 265 and actuator motor 161 microprocessor 285 can operate actuator motor 161 to cause actuator screw 160 to operate to close funnel drawer 56 and can cause scale 142 to re-verify the weight of vial 11 and dispensed pills to confirm the correct number of pills have been dispensed to fill the prescription.

Once vial 11 is filled and funnel drawer 56 is closed, controller 265 can cause vial transport module 35 to operate gripper drive motor 132 to cause gripper fingers 138 to close about the now filled vial 11 and scale motor 143 to lower scale 142 leaving the gripper 130 holding the vial 11. Controller 265 can then cause feed head module 60 to retract in the “z” direction to the “safe to rotate” position and rotatable arm 65 can be rotated to 180 degrees (see FIG. 9C).

After a vial 11 is labeled and the pills are dispensed into the vial 11, the controller 265 can operate the x-direction and y-direction vial transport module motors to position vial 11 at a selected height and lateral position suitable for depositing the vial 11 into the one of the receptacles 31 on a smart tote 30 assigned by controller 265 for the order group for a customer. It is contemplated that all of the filled vials 11 for a particular customer will be loaded onto one or more smart totes 30. Thus, all of the prescription orders 1 for a customer will be in one ready location, making it easy for the pharmacist to give the patient all of the prescription orders 1 in the customer order 2.

The vial transport module 35 can transport the filled vial 11 to position it behind and above an empty receptacle 31 on the appropriate smart tote 30 under control of controller 265. Smart totes 30 can then be locked in place as described above and the filled vial 11 can be placed in the selected receptacle 31 by feed head module 60 first advancing feed head module 60 on feed head support frame 64 to position filled vial 11 over the selected receptacle 31 and then lowering feed head module 60 all under control of the controller 265. With filled vial 11 positioned in a receptacle 31 gripper 130 can be caused to open gripper fingers 138 by controller 265 and the smart tote 30 can be unlocked after the gripper 130 opens gripper fingers 138 releasing vial 11 into the selected receptacle 31. Controller 265 can then retract feed head 60 and return rotatable arm 60 to the FIG. 9B position. Filling and placing of vials 11 onto smart tote 30 can continue until all prescription orders 1 that can be filled from the storage locations 118 are completed for the smart tote(s) 30 being processed for a customer's order 2. When one smart tote 30 is processed controller 265 can begin processing the prescription orders 1 for the next customer order 2 requiring automatic processing from the order database 256. If desired, the pharmacist can manually direct controller 265 to complete prescription orders 1 for a customer order 2 out of order to, for example, complete an urgent customer waiting order. As customer orders 2 are completed for one or more smart totes 30, conveyor 230 can advance smart totes 30 toward prescription checking station 20.

During the automatic processing of prescription orders 1 for a customer order 2 an LCD tote display 27 mounted in the front of the assigned smart tote 30 can provide a list of all the prescriptions to be included with that customer order 2, that can include one or more manually filled prescription orders 1 (for example prescriptions for drugs that are not in pill form or are not included in the drugs included in storage locations 118 of the pill dispensing apparatus 10 due to low volume or other considerations). Display 27 can be connected to a control board 300, not visible, that can include a microprocessor 285 that can be carried on a circuit board 286 that can be similar to control board 300 illustrated in FIG. 17. The person filling manual prescription orders 1 can retrieve printed labels from a manual printer 28 for the manually filled prescriptions and place them in a storage area 32 of the smart tote 30 and can use the printed labels 206 as pick tickets retrieve the manual prescription items to complete the customer order 2. Smart totes 30 can also include one or more LED indicators 239 that can be arranged as desired adjacent display 27. LED indicators 239 can be connected to a control board 300 circuit board 286 and microprocessor 285 and can be arranged to indicate the status of the smart tote 30 as desired. Smart totes 30 can include a power supply for the control board 300, not visible, that can include a rechargeable battery 39, and can include receiving pads 238 that can be arranged to communicate with induction charging pads 228 on conveyor 230, lift transfer modules 23 and return conveyor 240 as described above. Charging pads 228 and receiving pads 238 can include a circuit board, not visible, including a charging loop for induction charging as are well known in the art. The smart tote 30 circuit boards can also include electronic communication capability for an electronic communication link 310 between the respective smart totes 30 and controller 265 to enable the controller 265 to determine where the respective smart totes 30 are positioned on conveyor 230, lift transfer modules 23 or return conveyor 240. For example, electronic communication alternatives can include Zigbee, Bluetooth or WiFi communication links 310. As noted above, smart tote 30 circuit boards 300 can also be arranged to provide connection with the respective smart totes 30 by sliding connection, not visible, for a wired communication link 310 to controller 265 to provide secure communication of patient information without use of electronic communication if desired. Electronic communication links 310 with smart totes 30 can be limited to drug information and status to provide adequate data security. Date encryption can be used for communication link 310 data packets for sensitive information.

The pill dispensing apparatus 10 can also include a storage rack 33 that can have dividers 29 forming compartments 29′ having indicator lights 34. Compartments 29′ can be used to store pre-packaged drugs 33′ considered to be “top runners” that are not suitable for dispensing by a dispensing unit 40. Controller 25 can have a “pick to” light database 257 that can track the pre-packaged drugs 33′ that are stored in respective storage bins 29′. If an item in a customer order 2 is a top runner unit of use (pre-packaged in correct quantity), it can, as setup by the pharmacy, be placed in one of the compartments 29′ and the appropriate indicator 34 can identify the top runner unit as being needed to complete a customer order 2 for a smart tote 30 assigned for a customer's order 2. As mentioned above, a series of gates 8 can be pivotally mounted on hinges 9 below compartments 29′ arranged to preclude access to auto filled vial storage receptacles 31 on smart totes 30 when smart totes 30 are positioned on conveyor 230. A smart tote 30 can be removed by an operator from conveyor 230 when the smart tote is not locked by pivoting gate 8 outwardly on hinge 9 and lifting smart tote 30 from conveyor. Those skilled in the art will understand that storage locations in a pharmacy for medicines not stored in a dispensing unit 40 or a storage compartment 29′ can also be included in the “pick to” light database 257 and can have an indicator 34 to assist the operator in locating a medicine to fill a manually filled prescription order 1.

Once a pharmacist filling a manually filled prescription order 1 has the drug for the prescription the pharmacist can scan the barcode from the source of the drug (either the bulk container or unit of use) with a bar code reader 25 in the appropriate smart tote 30 (see FIGS. 19 and 19A) followed by scanning the label printed for the vial 11. The manually filled prescription can then be displayed as filled on the smart tote 30 display 27 under control of the microprocessor 285 for that smart tote 30. Once all the automatic and manually filled prescriptions in a customer order 2 are filled and placed in the appropriate smart tote 30 an indicator 39 adjacent the smart tote display 27 can identify the customer order 2 as ready to check.

Once a customer order 2 for a smart tote 30 is complete it can await a request from a checking pharmacist. Typically smart totes 30 having a complete customer order 2 will be in line at a prescription checking station 20. When a smart tote 30 is ready for checking by the checking pharmacist conveyor motor 232 can be operated under control of controller 265 and the microprocessor 285 for conveyor motor 232 to advance the smart tote 30 to the checking station 20. Typically one end of pill dispensing apparatus 10 can be used for a checking station 20 and the opposite end can be used as a restocking station 21 for restocking dispensing units 40. Referring to FIGS. 2 and 3, prescription checking station 20 can include a touch screen computer 24 that can be connected to order database 252 for accessing patient prescription information and checking database 259 in controller 265, a pharmacy computer 22, a keyboard 26, and other items as required to input, retrieve, and view customer information. Controller 265 can be operably connected to the components of the pill dispensing apparatus 10 by the communication link 310 and power link 312 to control and operate all systems of the pill dispensing apparatus 10. Those skilled in the art will understand that pharmacy computer 22 could be a laptop computer or other separate computer unit and can be connected to a pharmacy computer network and also to the internet for receiving electronic prescriptions for customers as well as manually entered prescriptions by pharmacy staff received in person from a customer or by telephone from a physician's office. Pharmacy computer 22 can be connected to a pharmacy printer 290 and/or billing computer 292 depending on the desires of the pharmacy (collectively referred to as the host computer or host system 330). The host system 330 can communicate with MCPC 250 via data exchange protocol or by a print capture box 294 for receiving data from host computer 22 to a pharmacy printer 290.

To check a customer order 2 the checking pharmacist can remove each of the vials filling a prescription order 1 from the smart tote 30 and position the label 206 barcode in front of bar code reader 25 in smart tote 30. As each vial prescription bar code is read the checking screen on touch screen computer 24 can activate showing the prescription information and a reference image of the medicine being checked. If everything is correct the pharmacist will push the “accept” button on the touch screen computer 24 and the prescription can be placed in the bag(s) for that order group. The pharmacist can continue until all prescription orders 1 for the customer order 2 are complete.

If while checking there is a prescription with too many pills, a window can pop up on touch screen computer 24 and ask if the pharmacist wants to return the over count of pills to inventory. Upon acknowledging a desire to do so an indicator 288 on the appropriate dispensing unit 40 can flash to alert the pharmacist of its location allowing the pharmacist to disengage dispensing unit latch 280 and pull the appropriate dispensing unit 40 partially out of storage location 118, slide open top cover 48 and drop the extra pill(s) into the container 41. If the wrong dispensing unit 40 is disengaged and withdrawn the checking screen can set off an alarm to alert the pharmacist of the error. Once the dispensing unit 40 is reinserted into storage location 118 and the dispensing unit latch and connector 289 are re-connected the inventory for that dispensing unit 40 can correct the count as indicated by the over-count screen. The (return to stock) will work after the same fashion except the quantity will be corrected by the dispensed amount.

Once a customer order 2 in a smart tote 30 at a checking station 20 is complete the smart tote 30 can be released to return conveyor 240. Once smart tote 30 is released to the return conveyor 240, lift transfer module 23 can rise to accept the advancing smart tote 30 (see FIGS. 3, 18 and 18A). Lift transfer module 23 can have a transfer belt drive motor 233 that can include a control board 300 including a microprocessor 285 that can be carried on a circuit board 286, not visible, that can be similar to the typical control board 300 illustrated in FIG. 17. Transfer drive belt motor 233 can be operated to drive transfer drive belts 234 to move the smart tote 30 onto the lift transfer module 23. Lift transfer module 23 can include a typical scissors lift mechanism, see FIG. 18A, driven by a lift transfer motor 235. Lift transfer motor 235 can include a control board 300 including a microprocessor 285 that can be carried on a circuit board 286, not visible, that can be similar to the typical control board 300 illustrated in FIG. 17. When a smart tote 30 customer order 2 is complete, checked and released, the lift transfer module 23 at the prescription checking station 20 can lower the smart tote 30 to return conveyor 240 and transfer drive belt motor 233 can operate transfer drive belts 234 (FIGS. 3 and 18) to convey the empty smart tote off the lift transfer module 23 and onto return conveyor 240. Return conveyor motor 232 can then operate to advance the empty smart tote 30 on return conveyor 240. The checking pharmacist can also release a smart tote 30 in the checking station 20 without releasing the next in line smart tote 30 allowing the pharmacist to retrieve a completed smart tote 30 out of order when the need arises by pivoting gate 8 outwardly on hinge 9 and lifting the smart tote 30 from conveyor 230.

Once the quantity of pills in a dispensing unit 40 falls below a predetermined level (that can be set by the pharmacy) an indicator 288 on the dispensing unit 40 can begin notifying the operator(s). Once a dispensing unit 40 is empty the dispensing unit 40 must be filled before a prescription order 1 for that drug can be filled. Until an empty dispensing unit 40 is refilled controller 265 can accept a manually filled prescription order 1 normally stored in the empty dispensing unit 40 and listed as automatic and can mark it as complete once a vial 11 filled with the required medicine is scanned at the smart tote 30. To replenish a dispensing unit 40, the dispensing unit 40 can be disengaged from its storage location 118 by operating dispensing unit latch 280 and withdrawing dispensing unit 40 from its storage location 118. A bulk container for that medicine can be scanned using a replenishing bar code scanner 220 that can be mounted on counter 12 or work surface 16 in the vicinity or restocking station 21 as illustrated in FIGS. 1-3, or other convenient location as desired by the pharmacy, and the lot number and expiration date can captured and stored in the drug database 254 and written to the microprocessor 285 that can be carried on circuit board 286 associated with the dispensing unit 40 as well as the inventory it holds when the dispensing unit 40 is reinstalled. Circuit board 286 can be mounted in dispensing unit latch 280 and can operate one or more indicators 288.

Referring to FIG. 16 the preferred method of operating the pill dispensing apparatus 10 can be briefly described as follows. Nonetheless, it is contemplated that a number of different variations are possible, while still staying within the parameters of the present invention. The method of operating the pill dispensing apparatus 10 can include taking a prescription order 1 from a customer and entering the prescription in host pharmacy computer 22. As noted above, customer prescription orders 1 can be entered into host system 330 such as by entering the prescription in pharmacy computer 22 manually, or electronically or by scanning a prescription order 1 into the host system 330. Once the pharmacy has approval to fill a prescription order it can release, at a minimum, the label information from the host system 330 to controller 265 and order database 252 for processing.

Upon receiving approval of the request to fill a prescription order 1, controller 265 can either return the prescription order 1 to the pharmacist (such as if the drug database 254 doesn't recognize the prescription), or send the prescription order to the order database 252. When a prescription order 1 is received by controller 265 it can be sorted in the order database 252 for a common customer order group 2 (other orders for the same patient) that can provide a means to determine if the customer order 2 is complete and not missing any items. Current systems do not necessarily provide a list of all the items in a customer order 2.

Controller 265 can refer to a dispensing unit database 258 of storage locations 118 in the pill dispensing apparatus 10 to see if the drug requested is available in one of the storage locations 118. If yes, the controller 265 can, in turn, order a vial 11 to be labeled and filled as described above. Using the order information in the order database 252 controller 265 can direct vial feed module 90 to feed a vial 11 to the appropriate labeler module 200. The controller 265 can then cause the labeler module 200 to print and apply the appropriate label 206 to the vial 11 after the vial feed module has fed a vial 11 into the labeler module 200 all as described above in detail.

Controller 265 can then cause vial transport module 35 to transport the labeled vial 11 to the appropriate dispensing unit 40. Once the vial 11 is in place at the appropriate dispensing unit 40, the controller 265 can then cause fill head module 60 to execute a fill routine as described above. As part of the vial 11 being placed at a dispensing unit 40, controller 265 can check the bar code on the prescription label 206 applied to the vial 11 and the bar code on the dispensing unit 40 using the feed head module bar code reader 151 to assure that the correct drug is being dispensed into the vial 11 as described above. Notably, the top of the vial 11 stays open after filling of the vial 11 by the pill dispensing apparatus so that the checking pharmacist can look at the pills in the filled vial 11, the prescription label 206 and the touch screen computer 24 to double check for accuracy and quality control purposes.

The fill routine can be as follows. The completeness of the label 206 and verification of the dispensing unit 40 contents can be performed by the feed head module bar code reader 151. The controller 265 can determine if there is a drug or pill profile stored in the drug database 254 for the particular type, size, and shape of the pills to be dispensed from the dispensing unit 40. If yes, the controller 265 can refer to the established feed profile. If no, the controller 265 can initiate a new feed profile subroutine. A new feed profile can begin at an established baseline, or can begin based on preprogrammed data relating to the shape, size, or type of pill being dispensed. Both steps then lead to a feed profile that can be stored in the drug database 254 so the controller 265 can retrieve the feed profile for a drug to be dispensed. The pill gate 54 can be opened by gate stepper motor 79 that can cause actuator finger 81 to engage tab 57 of pill gate 54 and lift pill gate 54 open. The roller drive motor 88 can begin to rotate drive 55 of the selected dispensing unit 40 through rotational drive head 86 pursuant to the profile for the drug stored in the selected dispensing unit 40. Scale 142 can count pills as the pills drop into the vial 11 as described above. Scale 142 can be sufficiently sensitive to discriminate to less than the weight of one pill. The controller 265 can repeatedly check to determine if the pill count is within 10% of the prescribed number of pills via communication with microprocessor 285 associated with the scale interface. If yes, the controller 265 can slow down the pill flow by directing the microprocessor 285 for roller drive motor 88 to slow the speed of rotation of rollers 52, 53 and can direct the microprocessor 285 for gate stepper motor 79 to begin lowering pill gate 54. The controller 265 can sequentially check to see if the required pill count is achieved. If yes, the controller 265 can deactivate the roller drive motor 88, close the pill gate 54 as described above in detail, and can send an actual count signal to the checking database 259 for controller 265. The controller 265 can then cause the vial transport module 35 to convey the filled vial 11 to its assigned smart tote 30 for pickup and final checking by the pharmacist all as described above in detail.

If the prescribed pill count is not successfully achieved (i.e., the pill count is within 10% but does not finish filling), the controller 265 can implement a decision process that can include a routine where a drop timer can be activated. In a drop timer routine if the pill count is achieved before a timer times out, controller 265 can send an actual count signal to the checking database 259. If the appropriate count is not achieved, the decision process can proceed by raising pill gate 54 and operating/pulsing roller drive motor 88 to dispense additional pills. The controller 265 can repeatedly and periodically continue the decision process until the full pill count is achieved or the timer times out.

The pill dispensing apparatus 10 can be constructed to operate at a fast prescription/vial fill rate of at least about 120 prescriptions per hour. The roller drive motor 88 can be controlled by the microprocessor 285 for roller drive motor 88 by controller 265 to achieve a desired pill flow rate. Controller 265 can adjust the speed of the rollers 52, 53 in real-time to maintain an optimal pill flow rate. As the pill count nears a final quantity the speed of the rollers 52, 53 can be adjusted to slow the flow to a desired rate, which can allow sufficient time to close pill gate 54 and to cease rotation of the rollers 52, 53 when the requested quantity of pills is reached. As pills exit the dispensing unit 40 the pills can fall through funnel drawer 56 as described above in detail to prevent cross contamination possible with some other systems currently in use. The funnel drawer 56 can be closed to prevent further pills from dropping from the dispensing unit 40 into the vial 11 again as described above.

A double helix can be added to the end of the rollers 52, 53 adjacent pill gate 54 that can function to split clumps of small pills into two feeds, as one helical ridge 52b or 53b pushes pills to the edge of the roller helix 52b or 53b for immediate exit and the other helical ridge 53b or 52b can pull stacked pills around the helical ridge 53b or 52b at a different pitch that can separate the pills before they drop from the edge of rollers 52, 53. In general, a double helix on roller 52 and 53 adjacent the outlet 38, such as for the last turn or two of helixes 52b and 53b, not shown, can increase the speed and separation of the pills being delivered and can thereby increase the accuracy of product delivery, as well as providing a passive technique that can feed both small and large pills from the same set of rollers 52 53 utilizing only flow regulating software in controller 265.

A restock routine can be initiated in the controller 265 by a manual request by the pharmacist to restock a dispensing unit 40 or by an empty dispensing unit 40 indicating a need to be restocked. Controller 265 can send a signal to aid in identifying the dispensing unit 40 for restock by an indicator light 288 such as a flashing LED, see FIG. 6A. Controller 265 can monitor to verify correct dispensing unit 40 is removed for restocking and can list the drug to be used on the restocking station 21 touch screen computer 24. The bulk supply for the drug to be restocked can be pulled from its storage location. The barcode typically provided on bulk supply containers for pills can be scanned at replenishing bar code scanner 220 to confirm the correct drug has been selected from storage. The top cover 48 of the dispensing unit 40 can be slid open, and the pharmacist can determine whether the quantity of pills in the bulk supply will fit into the dispensing unit. If not, an estimate of quantity added can be entered in the controller 265 via touch screen computer 24. If the exact quantity of added pills is known, the quantity can be entered on touch screen computer 24. Pills from the bulk supply container can then be put into the dispensing unit 40. The bulk supply container label can positioned in front of a camera 222 that can be associated with replenishing bar code scanner 220 and positioned on counter 12 as desired, and the lot and expiration of the new pills from the bulk container can be scanned for loading to the memory chip 285 on the circuit board 286 associated with the dispensing unit 40 when the dispensing unit is reinstalled. Camera 222 can also be provided with a drawer in which a new pill can be placed for capture of a digital image of the pill that can be stored in the drug database 254 to provide an image of the pill during the checking operation. The top cover 48 can then be closed on the dispensing unit 40 and the operator can place the dispensing unit 40 back in the open storage location 118. The restock procedure for the pill dispensing apparatus 10 is highly efficient and accurate, and includes good quality control to prevent errors.

After a vial 11 is filled, controller 265 can update the order database 252. Then the filled vial 11 can be transported to its assigned smart tote 30 where the prescription orders 1 for one patient/customer are collected (a customer order 2). As a customer order 2 is established a smart tote 30 can be assigned (more than one if necessary). The assigned smart tote 30 can provide a collection point for a customer order 2 including both automatically filled and manually filled prescription orders 1 for a patient/customer. The smart totes 30 can circulate on a conveyor 230 and a return conveyor 240, see FIGS. 2 and 3, in an under/over method well known in the art. The purpose of a smart tote 30 is to automatically provide a customer specific collection point with real time feedback via a display 27, that can be provided on each smart tote 30, to indicate visually to the operator(s) what the components of the customer order 2 for that smart tote 30 are missing to complete that customer's order 2. Smart totes 30 can include an interface to the controller 265 and communication link 310 that can include a microprocessor 285 that can be carried on circuit board 286 that can drive display 27. Smart totes 30 can also include a rechargeable battery 39 that can power the interface and microprocessor 285. Conveyor 230 and return conveyor 240 can have multiple induction charging pads 228, (see FIG. 19B), for charging a smart tote 30 at the charging stations. If desired a charging station can be provided for each location at which a smart tote 30 can be positioned on conveyor 230 or return conveyor 240 and each smart tote 30 can include a secondary coil associated with receiving pad 238 connected to the charging circuit for the smart tote 30. Similarly lift transfer modules 23 can include a charging pad 228 for smart totes 30 positioned on a lift transfer module 23. Induction charging systems as are well known. Smart totes 30 can communicate wirelessly via communication link 310 or can include a sliding connection to the communication link 310 with controller 265.

Once a manually filled prescription 1 is complete the prescription container or the bulk container can be scanned by the operator at the appropriate smart tote 30 and then the label 206 printed for that prescription can be scanned and the prescription can be placed in the smart tote 30 and will be displayed as filled on the smart tote display 27. Once all the automatic and manual prescriptions 1 are filled the smart tote display indicator 27 can identify the order group as ready to check.

Once a smart tote 30 is complete and has moved to a prescription checking station 20 at the end of the conveyor 230 it can await a request from the checking pharmacist. To check a customer order 2 the pharmacist can pick up each of the prescriptions to verify each prescription. For each prescription the pharmacist can view the image of the pill shape, size, type, and name displayed along with a picture of the pill stored in the drug database 254 on touch screen computer 24 as the pharmacist picks up the filled vial 11 so that the pharmacist can verify prescription order 1 has been filled with the correct drug and place a lid 4 on the vial 11 from the lid storage hopper 5. After each prescription in the customer order is verified the information regarding the prescriptions in the order can be sent by controller 265 to the pharmacy host system 330, and the billing information can be generated. The customer order 2 of prescriptions can then be given to the customer/patient.

To check a customer order 2 the checking pharmacist can remove the vials 11 from the smart tote 30 one by one and position the label 206 barcodes in front of the bar code scanner 25 in the smart tote 30, and once read a checking screen can be displayed on touch screen computer 24 showing the prescription information and a reference image of the drug being checked. If everything is correct the pharmacist can push an “accept” button on the touch screen computer 24, close the vial 11 with a vial lid 4 from a lid storage hopper 5 and the vial containing the medicine for the prescription order 1 can be placed in a bag(s) for that customer order 2. The pharmacist can continue verifying prescriptions until all prescription orders for the customer order 2 are complete.

If while checking there is a prescription with too many pills a window can pop up on the touch screen computer 24 to ask if over count pills are to be returned to the dispensing unit 40. If the checking pharmacist requests a return of the over count an indicator 288 on the appropriate dispensing unit 40 can flash to alert the pharmacist of its location so the pharmacist can disengage and partially retract the dispensing unit 40 from its storage location 118, slide top cover 48 open and drop the extra pill(s) into the container 41. If the wrong dispensing unit 40 is disengaged and pulled out of a storage location 118 the checking screen can display and/or cause an alarm to alert the pharmacist of the error. Once the extra pills have been returned to the correct dispensing unit 40 and the dispensing unit 40 is pushed back into its storage location 118 and re-connected the inventory for the dispensing unit 40 can be corrected by the count indicated on the over-count screen. The (return to stock) will work after the same fashion except the quantity will be corrected by the dispensed amount.

Once checking of a smart tote 30 in checking station 20 has been completed and the prescriptions removed and placed in a bag for the customer, the smart tote 30 can be released to the return conveyor 240. Lift transfer module 23 can rise to accept the released smart tote 30 as described above. The checking pharmacist can release a smart tote 30 in the checking station 20 without releasing the next smart tote 30 in line that can allow the checking pharmacist to retrieve a completed smart tote 30 out of order when the need arises by pivoting gate 8 outwardly on hinge 9 and lifting smart tote 30 from conveyor 230.

It is to be understood that variations and modifications can be made on the aforementioned structure without departing from the concepts of the present invention, and further it is to be understood that such concepts are intended to be covered by the following claims unless these claims by their language expressly state otherwise. Further, while the description and following claims refer to pills it is to be understood that the term pills is intended to generically refer to medicines in the form of pills, tablets, capsules and similar solid shapes and forms without limitation.

1. A pill dispensing apparatus for filing one or more prescriptions for a customer order having a plurality of storage locations for pill form medicines, a first side and a second side comprising:
a controller;
a conveyor extending substantially across the pill dispensing apparatus between the first side and the second side;
a plurality of smart totes carried on the conveyor for movement across the pill dispensing apparatus toward the second side arranged for accumulating prescriptions for a customer's order comprising:
a vial storage area arranged to receive vials of automatically filled prescriptions for a customer's order;
a storage area for manually filled prescriptions for a customer's order;
a circuit board and microprocessor arranged to provide an interface connection to controller; and
a tote display connected to the circuit board arranged for displaying the prescriptions for the customer's order assigned to the smart tote by controller;
a communication link operatively connecting the interface of respective smart totes with the controller;
a plurality of dispensing units respectively positioned in the plurality of storage locations each arranged to hold and dispense a pill form medicine to fill a prescription;
at least one vial feed module operatively connected to the controller and arranged to store empty vials and sequentially feed empty vials;
at least one labeler module operatively connected to the controller and arranged to receive vials from the at least one vial feed module and, under control of the controller, print and apply a label for one of the prescriptions for a customer's order to a vial; and
a vial transport module operatively connected to the controller and movably mounted to the pill dispensing apparatus to:
transport a labeled vial from the one of the at least one labeler modules to a location for automatically filling the vial for one of the prescriptions from a dispensing unit containing the pill form medicine corresponding to the label; and
transport the vial containing the one of the prescriptions to the vial storage area on the smart tote assigned to the customer's order.

2. The pill dispensing apparatus of claim 1, further including an order database arranged to accumulate order information for prescriptions required for a customer's order, wherein the controller is arranged to provide a list of automatically filled and manually filled prescriptions for the customer's order accumulated by the order database and display the list on the tote display of the smart tote assigned to the customer's order.

3. The pill dispensing apparatus of claim 2, wherein the pill dispensing apparatus further comprises a storage rack including dividers forming compartments extending across the pill dispensing apparatus adjacent the conveyor arranged for holding medicines for manually filled prescriptions.

4. The pill dispensing apparatus of claim 3, further including a pick to light database arranged to track the storage locations for manually filled prescription medicines including the compartments.

5. The pill dispensing apparatus of claim 4, further comprising one or more pick to light indicators associated with one or more of the storage locations.

6. The pill dispensing apparatus of claim 1, the vial transport module further comprising a feed head operatively connected to the controller and arranged to operate a dispensing unit to dispense the number of pills required to fill the one of the prescriptions into the vial.

7. The pill dispensing apparatus of claim 1, wherein the smart totes further comprise a rechargeable battery connected to the circuit board and a receiving pad, and wherein the conveyor further comprises at least one charging pad arranged for charging a smart tote rechargeable battery when the receiving pad is operatively connected to the at least one charging pad.

8. The pill dispensing apparatus of claim 7, wherein the conveyor comprises a plurality of charging pads arranged to charge all the smart totes on the conveyor.

9. The pill dispensing apparatus of claim 1 further including:
a return conveyor positioned below the conveyor for moving smart totes from the second side to the first side; and
lift transfer modules at the second side arranged to transport a smart tote from the conveyor to the return conveyor and at first side arranged to transport a smart tote from the return conveyor to the conveyor.

10. The pill dispensing apparatus of claim 1 further including a plurality of gates mounted on hinges to the pill dispensing apparatus above the smart totes on the conveyor to limit access to the vial storage receptacles and allow access to the storage area when the smart totes are positioned on the conveyor, and pivot upward on hinges to allow the smart totes to be removed from conveyor by an operator.

11. The pill dispensing apparatus of claim 1, wherein the smart totes further include a bar code reader connected to the circuit board and microprocessor and arranged for scanning and reading a bar code included on a label on a manually filled prescription package as the manually filled prescription is placed in the storage area, whereby the bar code information for the manually filled prescription is communicated to the controller.

12. A pill dispensing apparatus for filing one or more prescriptions for a customer order comprising:
a controller;
first and second spaced housings positioned to form a first side and second side of the pill dispensing apparatus;
an array of storage locations located between the first and second housings arranged to respectively receive dispensing units;
a work surface extending from the first side to the second side of the pill dispensing apparatus above the array of storage locations to form part of a top surface of the pill dispensing apparatus;
a conveyor extending substantially across the pill dispensing apparatus adjacent the work surface connected to the first and second housings to form part of the top surface of the pill dispensing apparatus and connected to the controller;
a return conveyor extending substantially across the pill dispensing apparatus positioned below the conveyor connected to the first and second housings and connected to the controller;
a plurality of smart totes carried on the conveyor and return conveyor for movement across the pill dispensing apparatus on the conveyor toward the second side for accumulating prescriptions for a customer's order and for movement across pill dispensing apparatus on the return conveyor toward the first side comprising:
vial storage receptacles arranged to receive vials of automatically filled prescriptions for a customer's order;
a storage area to receive manually filled prescriptions for a customer's order;
a circuit board and microprocessor arranged to provide an interface connection to the controller; and
a tote display connected to the circuit board arranged for displaying the prescriptions for the customer's order assigned to the smart tote by controller;
a communication link operatively connecting the interface of respective smart totes with the controller;
a lift transfer module at the second side arranged to transport a smart tote from the conveyor to the return conveyor and at the first side arranged to transport a smart tote from the return conveyor to the conveyor;
a plurality of dispensing units respectively positioned in the plurality of storage locations, each arranged to hold and dispense a pill form medicine to fill a prescription;
at least one vial feed module positioned in one of the first and second housings operatively connected to the controller and arranged to store empty vials and sequentially feed empty vials;
at least one labeler module positioned in the one of the first and second housings operatively connected to the controller and arranged to receive vials from the at least one vial feed module and, under control of the controller, print and apply a label for one of the prescriptions for a customer's order to a vial; and
a vial transport module including a feed head operatively connected to the controller and movably mounted to the pill dispensing apparatus to, under control of the controller:
transport a labeled vial from the one of the at least one labeler modules to the dispensing unit containing the pills to fill the one of the prescriptions corresponding to the label;
operate the dispensing unit to dispense the number of pills required to fill the one of the prescriptions into the vial; and
transport the vial containing the one of the prescriptions to a vial storage receptacle on the smart tote assigned to the customer's order.

13. The pill dispensing apparatus of claim 12, wherein a vial feed module and a labeler module are positioned in the each of the first and second housings.

14. The pill dispensing apparatus of claim 13, wherein the pill dispensing apparatus further comprises a storage rack including dividers forming compartments extending across the pill dispensing apparatus adjacent the conveyor opposite the work surface arranged for holding medicines for manually filled prescriptions.

15. The pill dispensing apparatus of claim 14, further including:
a pick to light database arranged to track storage locations for manually filled prescription medicines including the compartments; and
one or more pick to indicators operatively connected to the controller, whereby the controller can activate the one or more pick to indicators to indicate the location of medicines required to fill manually filled prescriptions for a customer's order.

16. The pill dispensing apparatus of claim 14 further including a plurality of gates mounted on hinges to the pill dispensing apparatus below storage rack above the smart totes on conveyor to limit access to the vial storage receptacles and allow access to the storage area when the smart totes are positioned on the conveyor, and pivot upward on hinges to allow the smart totes to be removed from conveyor by an operator.

17. The pill dispensing apparatus of claim 12, wherein the smart totes further include a bar code reader operatively connected to the circuit board and microprocessor and arranged for scanning and reading a bar code included on a label on a manually filled prescription package as the manually filled prescription is placed in the storage area, whereby the bar code information for the manually filled prescription is communicated to the controller.

18. The pill dispensing apparatus of claim 12, wherein the smart totes further comprise a rechargeable battery connected to the circuit board and a receiving pad, and wherein the conveyor, the return conveyor and the lift transfer modules further comprise at least one charging pad arranged for charging a smart tote rechargeable battery when the receiving pad is operatively connected to the at least one charging pad.

19. The pill dispensing apparatus of claim 18, wherein the conveyor and return conveyor comprise a plurality of charging pads arranged to charge all the smart totes on the conveyor and return conveyor.

20. The pill dispensing apparatus of claim 12, wherein at least the conveyor further comprises a conveyor lock motor connected to the controller arranged to drive a bevel gear to rotate a locking cam shaft carrying a plurality of locking cams, and wherein the smart totes further comprise locking posts; whereby when the controller causes the conveyor lock motor to rotate the locking cam shaft the locking cams engage the locking posts to prevent the smart totes from moving.
